(19) United States
(12) Patent Application Publication
(10) Pub. No.: US 2024/0348391 A1
(43) Pub. Date: Oct. 17, 2024

(54) TRANSMITTING DIFFERENTIAL PHYSIAL LAYER PROTOCOL DATA UNITS (PPDUS) TO ALLOW LOW LATENCY TRANSMISSION

(71) Applicant: NEWRACOM, Inc., Irvine, CA (US)

(72) Inventors: Heejung YU, Daejeon (KR); Joonsoo LEE, Seoul (KR); Si-Chan NOH, Seoul (KR)

(73) Assignee: NEWRACOM, Inc., Irvine, CA (US)

(21) Appl. No.: 18/632,828

(22) Filed: Apr. 11, 2024

Related U.S. Application Data
(60) Provisional application No. 63/495,503, filed on Apr. 11, 2023.

(51) Int. Cl. H04L 5/00

(52) U.S. Cl. CPC H04L 5/0048; H04L 5/0046

(57) ABSTRACT

Disclosed herein is a method performed by a wireless device in a wireless network to transmit differential physical layer protocol data units (PPDUs) to allow low latency transmission. The method includes wirelessly transmitting a plurality of PPDUs to a second wireless device using a x interframe space (xIFS) interval, wherein the xIFS interval comprises a signal processing interframe space (sIFS) interval that is used in the wireless network and a physical carrier sensing (Tpcs) interval during which other wireless devices are allowed to preempt transmission of the first wireless device.

### CROSS-REFERENCE TO RELATED APPLICATION

This application claims the benefit of U.S. Provisional Application No. 63/495,503, filed Apr. 11, 2023, titled, “Low latency transmission using differential PPDU allocation in wider bandwidth,” which is hereby incorporated by reference.

### TECHNICAL FIELD

The present disclosure generally relates to wireless communications, and more specifically, relates to transmitting differential physical layer protocol data units (PPDUs) to allow low latency transmission in a wireless network.

### BACKGROUND

Institute of Electrical and Electronics Engineers (IEEE) 802.11 is a set of physical and Media Access Control (MAC) specifications for implementing Wireless Local Area Network (WLAN) communications. These specifications provide the basis for wireless network products using the Wi-Fi brand managed and defined by the Wi-Fi Alliance. The specifications define the use of the 2.400-2.500 Gigahertz (GHz) as well as the 4.915-5.825 GHz bands. These spectrum bands are commonly referred to as the 2.4 GHz and 5 GHz bands. Each spectrum is subdivided into channels with a center frequency and bandwidth. The 2.4 GHz band is divided into 14 channels spaced 5 Megahertz (MHz) apart, though some countries regulate the availability of these channels. The 5 GHz band is more heavily regulated than the 2.4 GHz band and the spacing of channels varies across the spectrum with a minimum of a 5 MHz spacing dependent on the regulations of the respective country or territory.

WLAN devices are currently being deployed in diverse environments. These environments are characterized by the existence of many Access Points (APs) and non-AP stations (STAs) in geographically limited areas. Increased interference from neighboring devices gives rise to performance degradation. Additionally, WLAN devices are increasingly required to support a variety of applications such as video, cloud access, and offloading. Video traffic, in particular, is expected to be the dominant type of traffic in WLAN deployments. With the real-time requirements of some of these applications, WLAN users demand improved performance.

The scope of future wireless networking standards (e.g., beyond IEEE 802.11be) is expected to include low latency traffic delivery for real-time services such as virtual reality (VR), augmented reality (AR), and/or mixed reality (MR). With current wireless networking standards, if a station (STA) acquires a transmission opportunity (TXOP), other STAs are not allowed to transmit during the TXOP to guarantee the safe transmission of the TXOP owner's frames. TXOPs can last for a relatively long time. Such an operational scenario prevents low latency transmission (LLT) in the wireless network.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example wireless local area network (WLAN) with a basic service set (BSS) that includes a plurality of wireless devices, in accordance with some embodiments of the present disclosure.

FIG. 2 is a schematic diagram of a wireless device, in accordance with some embodiments of the present disclosure.

FIG. 3A illustrates components of a wireless device configured to transmit data, in accordance with some embodiments of the present disclosure.

FIG. 3B illustrates components of a wireless device configured to receive data, in accordance with some embodiments of the present disclosure.

FIG. 4 illustrates Inter-Frame Space (IFS) relationships, in accordance with some embodiments of the present disclosure.

FIG. 5 illustrates a Carrier Sense Multiple Access/Collision Avoidance (CSMA/CA) based frame transmission procedure, in accordance with some embodiments of the present disclosure.

FIG. 6 shows a table comparing various iterations of Institute of Electrical and Electronics Engineers (IEEE) 802.11 standard, in accordance with some embodiments of the present disclosure.

FIG. 7 shows a table, which describes fields of an Extreme High Throughput (EHT) frame format, in accordance with some embodiments of the present disclosure.

FIG. 8 is a diagram showing a situation in which an AP transmits a large data frame, which delays the transmission of the AP's low latency data.

FIG. 9 is a diagram showing a situation in which an AP transmits a large data frame, which delays the transmission of a LLT STA's low latency data.

FIG. 10 is a diagram showing an AP transmitting differential PPDUs and preempting its own transmission to transmit downlink low latency data, according to some embodiments.

FIG. 11 is a diagram showing an AP transmitting differential PPDUs and a STA preempting the AP's transmission to transmit uplink low latency data, according to some embodiments.

FIG. 12 is a diagram showing transmission of different length PPDUs in different subchannels, according to some embodiments.

FIG. 13 is a diagram showing a pause in transmission during a TXOP due to preemption, according to some embodiments.

FIG. 14 is a diagram showing bandwidth expansion of low latency transmission, according to some embodiments.

FIG. 15 is a diagram showing a PPDU end indication and padding to allow low latency transmission without having to wait for a sIFS interval, according to some embodiments.

FIG. 16 is a diagram showing bandwidth expansion of low latency transmission based on detecting PPDU end indication, according to some embodiments.

FIG. 17 is a diagram showing a configuration of a wireless device, according to some embodiments.

FIGS. 18A is a flow diagram showing a method for transmitting differential PPDUs to allow low latency transmission, according to some embodiments.

FIG. 18B is a flow diagram showing a further operations for transmitting differential PPDUs to allow low latency transmission, according to some embodiments.

FIG. 19 is a flow diagram showing a method for transmitting data with low latency, according to some embodiments.

### DETAILED DESCRIPTION

One aspect of the present disclosure generally relates to wireless communications, and more specifically, relates to transmitting differential physical layer protocol data units (PPDUs) to allow low latency transmission in a wireless network.

As mentioned above, with current wireless networking standards, if a station (STA) acquires a transmission opportunity (TXOP), other STAs are not allowed to transmit during the TXOP to guarantee the safe transmission of the TXOP owner's frames. TXOPs can last for a relatively long time. Such an operational scenario prevents low latency transmission (LLT) in the wireless network.

Embodiments are disclosed herein that can guarantee long TXOPs for high throughput STAs, while at the same time giving low latency transmission (LLT) STAs (STAs that have low latency data to transmit) an opportunity to access the wireless medium during the middle of a TXOP acquired by a non-LLT STA in a wireless network that uses a distributed competition-based channel access mechanism. Embodiments achieve this by having a non-LLT STA transmit differential PPDUs using a x interframe space (xIFS) interval, where LLT STAs are allowed to preempt the transmission of the non-LLT STA by transmitting a preempting PPDU that includes low latency data during a xIFS interval. PPDUs that are transmitted using a xIFS interval to allow preemption during the xIFS interval may be considered as differential PPDUs or fragmented PPDUs. To further reduce latency, a LLT STA may dynamically expand the bandwidth it uses for preemption by preempting additional transmissions in additional subchannels in which differential PPDUs are transmitted. Also, a differential PPDU may include a PPDU end indication and padding (dummy signal) to allow LLT STAs to detect the end of a differential PPDU and transmit a preempting PPDU with even less delay.

According to some embodiments, a first wireless device wirelessly transmits a plurality of PPDUs to a second wireless device using a x interframe space (xIFS) interval. That is, the first wireless device transmits PPDUs with an xIFS interval between consecutive PPDUs. The xIFS interval may comprise a signal processing interframe space (sIFS) interval that is used in the wireless network (e.g., short interframe space interval (SIFS) or reduced interframe space interval (RIFS)) and a physical carrier sensing (Tpcs) interval during which other wireless devices are allowed to preempt transmission of the first wireless device.

Another wireless device, which may be referred to as the third wireless device, may preempt transmission of the first wireless device by wirelessly transmitting a preempting PPDU that includes low latency data following the transmission of one of the plurality of PPDUs by the first wireless device. The third wireless device may transmit the preempting PPDU after a sIFS interval following the transmission of the PPDU by the first wireless device (e.g., during the Tpcs interval of a xIFS interval). The first wireless device may detect the preempting PPDU based on carrier sensing.

Responsive to detecting the preempting PPDU transmitted by the third wireless device, the first wireless device may pause transmission of further PPDUs to the second wireless device to receive the preempting PPDU. If the first wireless device successfully receives a frame included in the preempting PPDU, the first wireless device may wirelessly transmit a block acknowledgement (ACK) frame to the third wireless device to acknowledge the frame included in the preempting PPDU. The first wireless device may then resume transmission of further PPDUs to the second wireless device using the xIFS interval following transmission of the BA frame.

In an embodiment, the first wireless device identifies a first subchannel of a plurality of subchannels that has the poorest channel quality (e.g., lowest signal-to-noise ratio (SNR)) among a plurality of subchannels and transmits the plurality of PPDUs in the first subchannel. The first wireless device may wirelessly transmit PPDUs that are longer than the PPDUs transmitted in the first subchannel in one or more other subchannels of the plurality of subchannels that have better channel quality (e.g., higher SNR) than the first subchannel.

In an embodiment, to further reduce latency, the third wireless device expands the bandwidth used for preemption by preempting one or more transmissions in the one or more other subchannels (e.g., by transmitting during a xIFS interval in the one or more other subchannels) while still preempting the transmission in the first subchannel. By expanding the bandwidth used to transmit low latency data (using a wider bandwidth), the latency to deliver the low latency data can be further reduced.

In an embodiment, differential PPDUs include a PPDU end indication and padding following the PPDU end indication to allow other wireless devices (e.g., the third wireless device) to preempt transmission of the first wireless device without having to wait for the sIFS interval. If the third wireless device detects the PPDU end indication in a differential PPDU transmitted by the first wireless device, the third wireless device may wirelessly transmit a preempting PPDU to the first wireless device immediately after the transmission of the differential PPDU, without waiting for the sIFS interval after receiving the differential PPDU. Thus, the third wireless device may preempt the transmission of the first wireless device immediately after the transmission of a differential PPDU ends (so xIFS effectively becomes Tpcs). Thus, the non-LLT device does not need to guarantee RX signal processing time (shortening or removing the sIFS interval from xIFS interval), and thus low latency transmission is possible immediately (e.g., xIFS=Tpcs).

For purposes of illustration, various embodiments are described herein in the context of wireless networks that are based on IEEE 802.11 standards and using terminology and concepts thereof. Those skilled in the art will appreciate that the embodiments disclosed herein can be modified/adapted for use in other types of wireless networks.

In the following detailed description, only certain embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

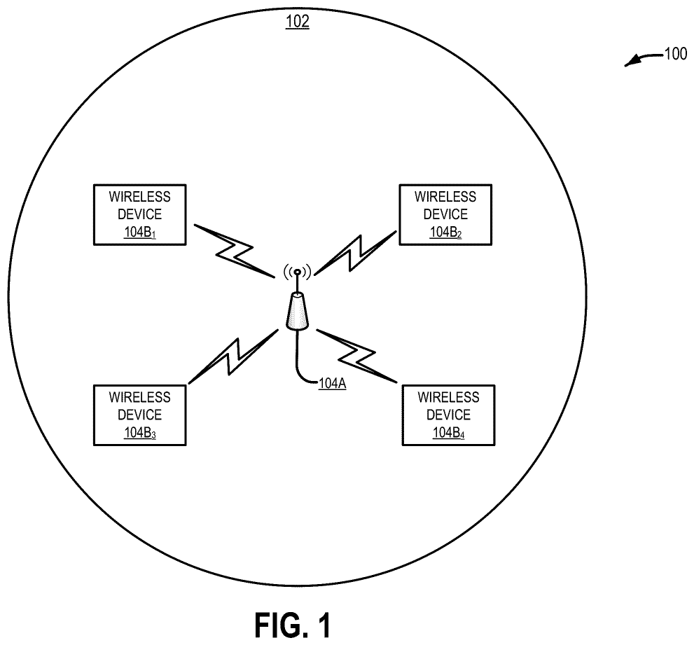

FIG. 1 shows a wireless local area network (WLAN) 100 with a basic service set (BSS) 102 that includes a plurality of wireless devices 104 (sometimes referred to as WLAN devices 104). Each of the wireless devices 104 may include a medium access control (MAC) layer and a physical (PHY) layer according to an IEEE (Institute of Electrical and Electronics Engineers) standard 802.11, including one or more of the amendments (e.g., 802.11a/b/g/n/p/ac/ax/bd/be). In one embodiment, the MAC layer of a wireless device 104 may initiate transmission of a frame to another wireless device 104 by passing a PHY-TXSTART.request (TXVECTOR) to the PHY layer. The TXVECTOR provides parameters for generating and/or transmitting a corresponding frame. Similarly, a PHY layer of a receiving wireless device may generate an RXVECTOR, which includes parameters of a received frame and is passed to a MAC layer for processing.

The plurality of wireless devices 104 may include a wireless device 104A that is an access point (sometimes referred to as an AP station or AP STA) and the other wireless devices 104B1-104B4 that are non-AP stations (sometimes referred to as non-AP STAs). Alternatively, all the plurality of wireless devices 104 may be non-AP STAs in an ad-hoc networking environment. In general, the AP STA (e.g., wireless device 104A) and the non-AP STAs (e.g., wireless devices 104B1-104B4) may be collectively referred to as STAs. However, for ease of description, only the non-AP STAs may be referred to as STAs. Although shown with four non-AP STAs (e.g., the wireless devices 104B1-104B4), the WLAN 100 may include any number of non-AP STAs (e.g., one or more wireless devices 104B).

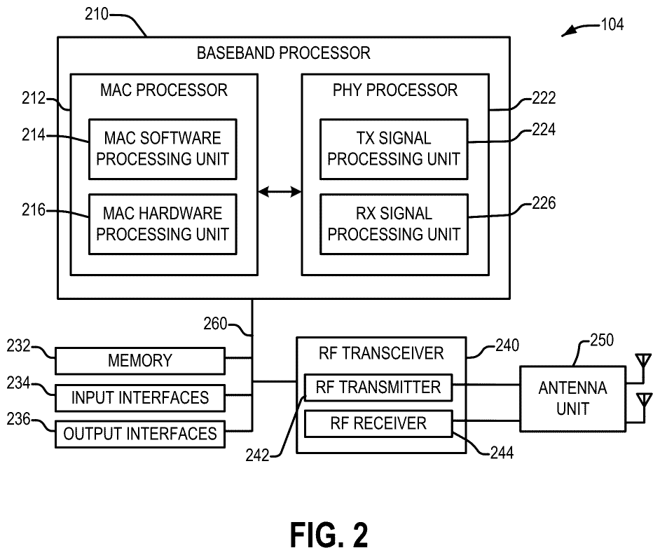

FIG. 2 illustrates a schematic block diagram of a wireless device 104, according to an embodiment. The wireless device 104 may be the wireless device 104A (i.e., the AP of the WLAN 100) or any of the wireless devices 104B1-104B4 in FIG. 1. The wireless device 104 includes a baseband processor 210, a radio frequency (RF) transceiver 240, an antenna unit 250, a storage device (e.g., memory device) 232, one or more input interfaces 234, and one or more output interfaces 236. The baseband processor 210, the storage device 232, the input interfaces 234, the output interfaces 236, and the RF transceiver 240 may communicate with each other via a bus 260.

The baseband processor 210 performs baseband signal processing and includes a MAC processor 212 and a PHY processor 222. The baseband processor 210 may utilize the memory 232, which may include a non-transitory computer/machine readable medium having software (e.g., computer/machine programing instructions) and data stored therein.

In an embodiment, the MAC processor 212 includes a MAC software processing unit 214 and a MAC hardware processing unit 216. The MAC software processing unit 214 may implement a first plurality of functions of the MAC layer by executing MAC software, which may be included in the software stored in the storage device 232. The MAC hardware processing unit 216 may implement a second plurality of functions of the MAC layer in special-purpose hardware. However, the MAC processor 212 is not limited thereto. For example, the MAC processor 212 may be configured to perform the first and second plurality of functions entirely in software or entirely in hardware according to an implementation.

The PHY processor 222 includes a transmitting (TX) signal processing unit (SPU) 224 and a receiving (RX) SPU 226. The PHY processor 222 implements a plurality of functions of the PHY layer. These functions may be performed in software, hardware, or a combination thereof according to an implementation.

Functions performed by the transmitting SPU 224 may include one or more of Forward Error Correction (FEC) encoding, stream parsing into one or more spatial streams, diversity encoding of the spatial streams into a plurality of space-time streams, spatial mapping of the space-time streams to transmit chains, inverse Fourier Transform (iFT) computation, Cyclic Prefix (CP) insertion to create a Guard Interval (GI), and the like. Functions performed by the receiving SPU 226 may include inverses of the functions performed by the transmitting SPU 224, such as GI removal, Fourier Transform computation, and the like.

The RF transceiver 240 includes an RF transmitter 242 and an RF receiver 244. The RF transceiver 240 is configured to transmit first information received from the baseband processor 210 to the WLAN 100 (e.g., to another WLAN device 104 of the WLAN 100) and provide second information received from the WLAN 100 (e.g., from another WLAN device 104 of the WLAN 100) to the baseband processor 210.

The antenna unit 250 includes one or more antennas. When Multiple-Input Multiple-Output (MIMO) or Multi-User MIMO (MU-MIMO) is used, the antenna unit 250 may include a plurality of antennas. In an embodiment, the antennas in the antenna unit 250 may operate as a beam-formed antenna array. In an embodiment, the antennas in the antenna unit 250 may be directional antennas, which may be fixed or steerable.

The input interfaces 234 receive information from a user, and the output interfaces 236 output information to the user. The input interfaces 234 may include one or more of a keyboard, keypad, mouse, touchscreen, microphone, and the like. The output interfaces 236 may include one or more of a display device, touch screen, speaker, and the like.

As described herein, many functions of the WLAN device 104 may be implemented in cither hardware or software. Which functions are implemented in software and which functions are implemented in hardware will vary according to constraints imposed on a design. The constraints may include one or more of design cost, manufacturing cost, time to market, power consumption, available semiconductor technology, etc.

As described herein, a wide variety of electronic devices, circuits, firmware, software, and combinations thereof may be used to implement the functions of the components of the WLAN device 104. Furthermore, the WLAN device 104 may include other components, such as application processors, storage interfaces, clock generator circuits, power supply circuits, and the like, which have been omitted in the interest of brevity.

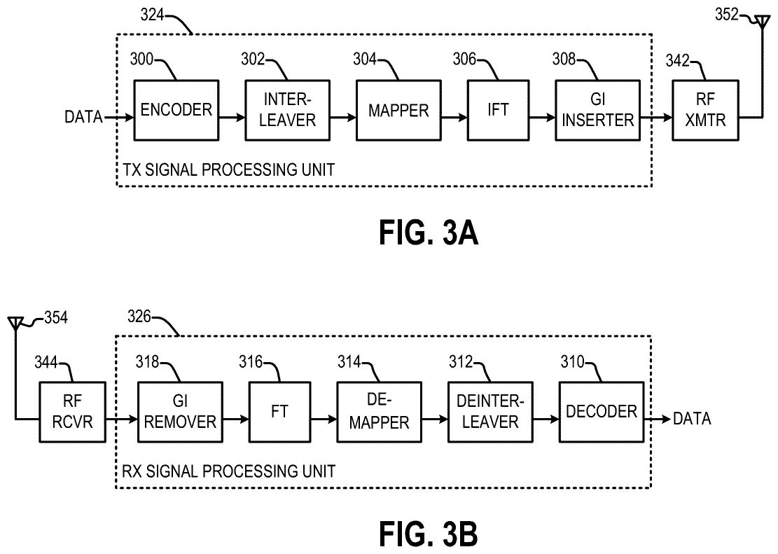

FIG. 3A illustrates components of a WLAN device 104 configured to transmit data according to an embodiment, including a transmitting (Tx) SPU (TxSP) 324, an RF transmitter 342, and an antenna 352. In an embodiment, the TxSP 324, the RF transmitter 342, and the antenna 352 correspond to the transmitting SPU 224, the RF transmitter 242, and an antenna of the antenna unit 250 of FIG. 2, respectively.

The TxSP 324 includes an encoder 300, an interleaver 302, a mapper 304, an inverse Fourier transformer (IFT) 306, and a guard interval (GI) inserter 308.

The encoder 300 receives and encodes input data. In an embodiment, the encoder 300 includes a forward error correction (FEC) encoder. The FEC encoder may include a binary convolution code (BCC) encoder followed by a puncturing device. The FEC encoder may include a low-density parity-check (LDPC) encoder.

The TxSP 324 may further include a scrambler for scrambling the input data before the encoding is performed by the encoder 300 to reduce the probability of long sequences of Os or Is. When the encoder 300 performs the BCC encoding, the TxSP 324 may further include an encoder parser for demultiplexing the scrambled bits among a plurality of BCC encoders. If LDPC encoding is used in the encoder, the TxSP 324 may not use the encoder parser.

The interleaver 302 interleaves the bits of each stream output from the encoder 300 to change an order of bits therein. The interleaver 302 may apply the interleaving only when the encoder 300 performs BCC encoding and otherwise may output the stream output from the encoder 300 without changing the order of the bits therein.

The mapper 304 maps the sequence of bits output from the interleaver 302 to constellation points. If the encoder 300 performed LDPC encoding, the mapper 304 may also perform LDPC tone mapping in addition to constellation mapping.

When the TxSP 324 performs a MIMO or MU-MIMO transmission, the TxSP 324 may include a plurality of interleavers 302 and a plurality of mappers 304 according to a number of spatial streams (NSS) of the transmission. The TxSP 324 may further include a stream parser for dividing the output of the encoder 300 into blocks and may respectively send the blocks to different interleavers 302 or mappers 304. The TxSP 324 may further include a space-time block code (STBC) encoder for spreading the constellation points from the spatial streams into a number of space-time streams (NSTS) and a spatial mapper for mapping the space-time streams to transmit chains. The spatial mapper may use direct mapping, spatial expansion, or beamforming.

The IFT 306 converts a block of the constellation points output from the mapper 304 (or, when MIMO or MU-MIMO is performed, the spatial mapper) to a time domain block (i.e., a symbol) by using an inverse discrete Fourier transform (IDFT) or an inverse fast Fourier transform (IFFT). If the STBC encoder and the spatial mapper are used, the IFT 306 may be provided for each transmit chain.

When the TxSP 324 performs a MIMO or MU-MIMO transmission, the TxSP 324 may insert cyclic shift diversities (CSDs) to prevent unintentional beamforming. The TxSP 324 may perform the insertion of the CSD before or after the IFT 306. The CSD may be specified per transmit chain or may be specified per space-time stream. Alternatively, the CSD may be applied as a part of the spatial mapper.

When the TxSP 324 performs a MIMO or MU-MIMO transmission, some blocks before the spatial mapper may be provided for each user.

The GI inserter 308 prepends a GI to each symbol produced by the IFT 306. Each GI may include a Cyclic Prefix (CP) corresponding to a repeated portion of the end of the symbol that the GI precedes. The TxSP 324 may optionally perform windowing to smooth edges of each symbol after inserting the GI.

The RF transmitter 342 converts the symbols into an RF signal and transmits the RF signal via the antenna 352. When the TxSP 324 performs a MIMO or MU-MIMO transmission, the GI inserter 308 and the RF transmitter 342 may be provided for each transmit chain.

FIG. 3B illustrates components of a WLAN device 104 configured to receive data according to an embodiment, including a Receiver (Rx) SPU (RxSP) 326, an RF receiver 344, and an antenna 354. In an embodiment, the RxSP 326, RF receiver 344, and antenna 354 may correspond to the receiving SPU 226, the RF receiver 244, and an antenna of the antenna unit 250 of FIG. 2, respectively.

The RxSP 326 includes a GI remover 318, a Fourier transformer (FT) 316, a demapper 314, a deinterleaver 312, and a decoder 310.

The RF receiver 344 receives an RF signal via the antenna 354 and converts the RF signal into symbols. The GI remover 318 removes the GI from each of the symbols. When the received transmission is a MIMO or MU-MIMO transmission, the RF receiver 344 and the GI remover 318 may be provided for each receive chain.

The FT 316 converts each symbol (that is, each time domain block) into a frequency domain block of constellation points by using a discrete Fourier transform (DFT) or a fast Fourier transform (FFT). The FT 316 may be provided for each receive chain.

When the received transmission is the MIMO or MU-MIMO transmission, the RxSP 326 may include a spatial demapper for converting the respective outputs of the FTs 316 of the receiver chains to constellation points of a plurality of space-time streams, and an STBC decoder for despreading the constellation points from the space-time streams into one or more spatial streams.

The demapper 314 demaps the constellation points output from the FT 316 or the STBC decoder to bit streams. If the received transmission was encoded using LDPC encoding, the demapper 314 may further perform LDPC tone demapping before performing the constellation demapping.

The deinterleaver 312 deinterleaves the bits of each stream output from the demapper 314. The deinterleaver 312 may perform the deinterleaving only when the received transmission was encoded using BCC encoding, and otherwise may output the stream output by the demapper 314 without performing deinterleaving.

When the received transmission is the MIMO or MU-MIMO transmission, the RxSP 326 may use a plurality of demappers 314 and a plurality of deinterleavers 312 corresponding to the number of spatial streams of the transmission. In this case, the RxSP 326 may further include a stream deparser for combining the streams output from the deinterleavers 312.

The decoder 310 decodes the streams output from the deinterleaver 312 or the stream deparser. In an embodiment, the decoder 310 includes an FEC decoder. The FEC decoder may include a BCC decoder or an LDPC decoder.

The RxSP 326 may further include a descrambler for descrambling the decoded data. When the decoder 310 performs BCC decoding, the RxSP 326 may further include an encoder deparser for multiplexing the data decoded by a plurality of BCC decoders. When the decoder 310 performs the LDPC decoding, the RxSP 326 may not use the encoder deparser.

Before making a transmission, wireless devices such as wireless device 104 will assess the availability of the wireless medium using Clear Channel Assessment (CCA). If the medium is occupied, CCA may determine that it is busy, while if the medium is available, CCA determines that it is idle.

The PHY entity for IEEE 802.11 is based on Orthogonal Frequency Division Multiplexing (OFDM) or Orthogonal Frequency Division Multiple Access (OFDMA). In either OFDM or OFDMA Physical (PHY) layers, a STA (e.g., a wireless device 104) is capable of transmitting and receiving Physical Layer (PHY) Protocol Data Units (PPDUs) that are compliant with the mandatory PHY specifications. A PHY specification defines a set of Modulation and Coding Schemes (MCS) and a maximum number of spatial streams. Some PHY entities define downlink (DL) and uplink (UL) Multi-User (MU) transmissions having a maximum number of space-time streams (STS) per user and employing up to a predetermined total number of STSs. A PHY entity may provide support for 10 Megahertz (MHz), 20 MHz, 40 MHz, 80 MHz, 160 MHz, 240 MHz, and 320 MHz contiguous channel widths and support for an 80+80, 80+160 MHz, and 160+160 MHz non-contiguous channel width. Each channel includes a plurality of subcarriers, which may also be referred to as tones. A PHY entity may define signaling fields denoted as Legacy Signal (L-SIG), Signal A (SIG-A), and Signal B (SIG-B), and the like within a PPDU by which some necessary information about PHY Service Data Unit (PSDU) attributes are communicated. The descriptions below, for sake of completeness and brevity, refer to OFDM-based 802.11 technology. Unless otherwise indicated, a station refers to a non-AP STA.

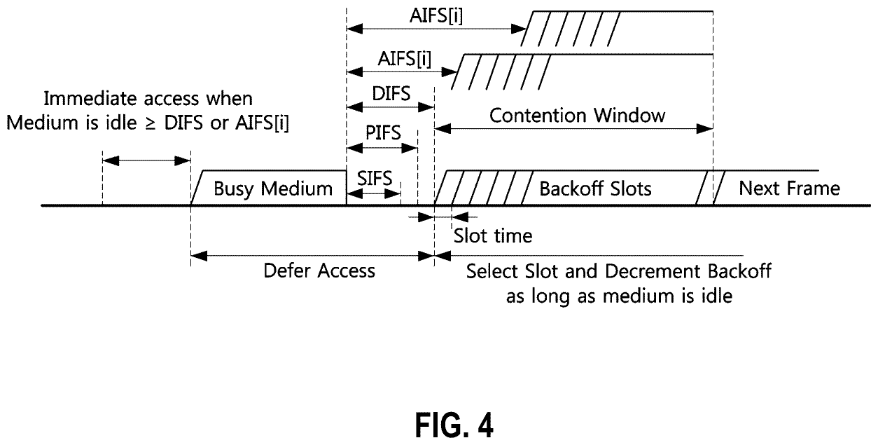

FIG. 4 illustrates Inter-Frame Space (IFS) relationships. In particular, FIG. 4 illustrates a Short IFS (SIFS), a Point Coordination Function (PCF) IFS (PIFS), a Distributed Coordination Function (DCF) IFS (DIFS), and an Arbitration IFSs corresponding to an Access Category (AC) ‘i’ (AIFS [i]). FIG. 4 also illustrates a slot time and a data frame is used for transmission of data forwarded to a higher layer. As shown, a WLAN device 104 transmits the data frame after performing backoff if a DIFS has elapsed during which the medium has been idle.

A management frame may be used for exchanging management information, which is not forwarded to the higher layer. Subtype frames of the management frame include a beacon frame, an association request/response frame, a probe request/response frame, and an authentication request/response frame.

A control frame may be used for controlling access to the medium. Subtype frames of the control frame include a request to send (RTS) frame, a clear to send (CTS) frame, and an acknowledgement (ACK) frame.

When the control frame is not a response frame of another frame, the WLAN device 104 transmits the control frame after performing backoff if a DIFS has elapsed during which the medium has been idle. When the control frame is the response frame of another frame, the WLAN device 104 transmits the control frame after a SIFS has clapsed without performing backoff or checking whether the medium is idle.

A WLAN device 104 that supports Quality of Service (QOS) functionality (that is, a QOS STA) may transmit the frame after performing backoff if an AIFS for an associated access category (AC) (i.e., AIFS [AC]) has elapsed. When transmitted by the QOS STA, any of the data frame, the management frame, and the control frame, which is not the response frame, may use the AIFS [AC] of the AC of the transmitted frame.

A WLAN device 104 may perform a backoff procedure when the WLAN device 104 that is ready to transfer a frame finds the medium busy. The backoff procedure includes determining a random backoff time composed of N backoff slots, where each backoff slot has a duration equal to a slot time and N being an integer number greater than or equal to zero. The backoff time may be determined according to a length of a Contention Window (CW). In an embodiment, the backoff time may be determined according to an AC of the frame. All backoff slots occur following a DIFS or Extended IFS (EIFS) period during which the medium is determined to be idle for the duration of the period.

When the WLAN device 104 detects no medium activity for the duration of a particular backoff slot, the backoff procedure shall decrement the backoff time by the slot time. When the WLAN device 104 determines that the medium is busy during a backoff slot, the backoff procedure is suspended until the medium is again determined to be idle for the duration of a DIFS or EIFS period. The WLAN device 104 may perform transmission or retransmission of the frame when the backoff timer reaches zero.

The backoff procedure operates so that when multiple WLAN devices 104 are deferring and execute the backoff procedure, each WLAN device 104 may select a backoff time using a random function and the WLAN device 104 that selects the smallest backoff time may win the contention, reducing the probability of a collision.

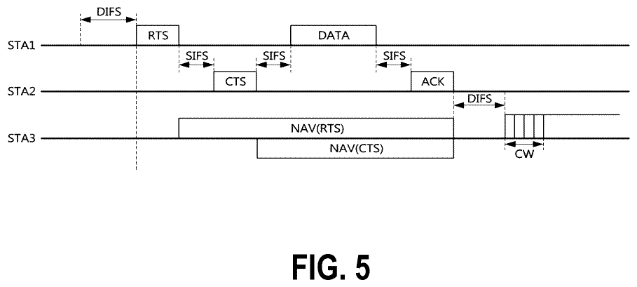

FIG. 5 illustrates a Carrier Sense Multiple Access/Collision Avoidance (CSMA/CA) based frame transmission procedure for avoiding collision between frames in a channel according to an embodiment. FIG. 5 shows a first station STA1 transmitting data, a second station STA2 receiving the data, and a third station STA3 that may be located in an area where a frame transmitted from the STA1 can be received, a frame transmitted from the second station STA2 can be received, or both can be received. The stations STA1, STA2, and STA3 may be WLAN devices 104 of FIG. 1.

The station STA1 may determine whether the channel is busy by carrier sensing. The station STA1 may determine channel occupation/status based on an energy level in the channel or an autocorrelation of signals in the channel, or may determine the channel occupation by using a network allocation vector (NAV) timer.

After determining that the channel is not used by other devices (that is, that the channel is IDLE) during a DIFS (and performing backoff if required), the station STA1 may transmit a Request-To-Send (RTS) frame to the station STA2. Upon receiving the RTS frame, after a SIFS the station STA2 may transmit a Clear-To-Send (CTS) frame as a response to the RTS frame. If Dual-CTS is enabled and the station STA2 is an AP, the AP may send two CTS frames in response to the RTS frame (e.g., a first CTS frame in a non-High Throughput format and a second CTS frame in the HT format).

When the station STA3 receives the RTS frame, it may set a NAV timer of the station STA3 for a transmission duration of subsequently transmitted frames (for example, a duration of SIFS+CTS frame duration+SIFS+data frame duration+SIFS+ACK frame duration) using duration information included in the RTS frame. When the station STA3 receives the CTS frame, it may set the NAV timer of the station STA3 for a transmission duration of subsequently transmitted frames using duration information included in the CTS frame. Upon receiving a new frame before the NAV timer expires, the station STA3 may update the NAV timer of the station STA3 by using duration information included in the new frame. The station STA3 does not attempt to access the channel until the NAV timer expires.

When the station STA1 receives the CTS frame from the station STA2, it may transmit a data frame to the station STA2 after a SIFS period elapses from a time when the CTS frame has been completely received. Upon successfully receiving the data frame, the station STA2 may transmit an ACK frame as a response to the data frame after a SIFS period elapses.

When the NAV timer expires, the third station STA3 may determine whether the channel is busy using the carrier sensing. Upon determining that the channel is not used by other devices during a DIFS period after the NAV timer has expired, the station STA3 may attempt to access the channel after a contention window elapses according to a backoff process.

When Dual-CTS is enabled, a station that has obtained a transmission opportunity (TXOP) and that has no data to transmit may transmit a CF-End frame to cut short the TXOP. An AP receiving a CF-End frame having a Basic Service Set Identifier (BSSID) of the AP as a destination address may respond by transmitting two more CF-End frames: a first CF-End frame using Space Time Block Coding (STBC) and a second CF-End frame using non-STBC. A station receiving a CF-End frame resets its NAV timer to 0 at the end of the PPDU containing the CF-End frame. FIG. 5 shows the station STA2 transmitting an ACK frame to acknowledge the successful reception of a frame by the recipient.

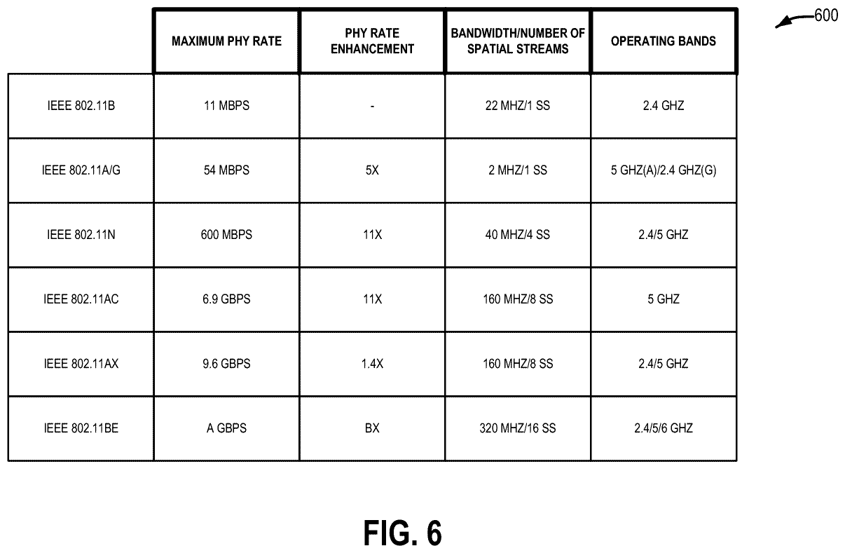

With clear demand for higher peak throughput/capacity in a WLAN, a new working group has been assembled to generate an amendment to IEEE 802.11. This amendment is called IEEE 802.11bc (i.e., Extreme High Throughput (EHT)) and was created to support an increase to the peak PHY rate of a corresponding WLAN. Considering IEEE 802.11b through 802.11ac, the peak PHY rate has been increased by 5× to 11× as shown in FIG. 6, which presents a table 600 comparing various iterations of IEEE 802.11. In case of IEEE 802.11ax, the 802.11ax working group focused on improving efficiency, not peak PHY rate in dense environments. The maximum PHY rate (A Gbps) and PHY rate enhancement (Bx) for IEEE 802.11be could rely on the highest MCS (e.g., 4,096 QAM and its code rate).

The focus of IEEE 802.11be is primarily on WLAN indoor and outdoor operation with stationary and pedestrian speeds in the 2.4, 5, and 6 GHz frequency bands. In addition to peak PHY rate, different candidate features are under discussion. These candidate features include (1) a 320 MHz bandwidth and a more efficient utilization of a non-contiguous spectrum, (2) multi-band/multi-channel aggregation and operation, (3) 16 spatial streams and Multiple Input Multiple Output (MIMO) protocol enhancements, (4) multi-Access Point (AP) Coordination (e.g., coordinated and joint transmission), (5) an enhanced link adaptation and retransmission protocol (e.g., Hybrid Automatic Repeat Request (HARQ)), and (6) adaptation to regulatory rules specific to a 6 GHz spectrum.

Some features, such as increasing the bandwidth and the number of spatial streams, arc solutions that have been proven to be effective in previous projects focused on increasing link throughput and on which feasibility demonstration is achievable.

With respect to operational bands (e.g., 2.4/5/6 GHZ) for IEEE 802.11be, more than 1 GHz of additional unlicensed spectrum is likely to be available because the 6 GHz band (5.925-7.125 GHZ) is being considered for unlicensed use. This would allow APs and STAs to become tri-band devices. Larger than 160 MHz data transmissions (e.g., 320 MHZ) could be considered to increase the maximum PHY rate. For example, 320 MHz or 160+160 MHz data could be transmitted in the 6 GHz band. For example, 160+160 MHz data could be transmitted across the 5 and 6 GHz bands.

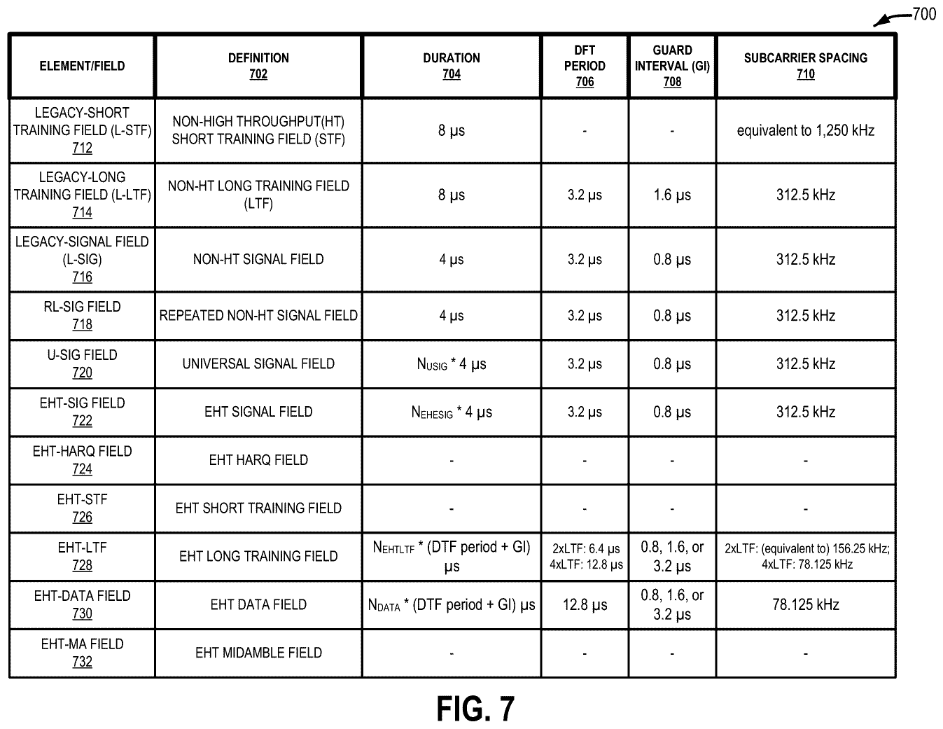

In some embodiments, a transmitting STA generates a PPDU frame and transmits it to a receiving STA. The receiving STA receives, detects, and processes the PPDU. The PPDU can be an EHT PPDU that includes a legacy part (e.g., a legacy short training field (L-STF), a legacy long training field (L-LTF), and a legacy signal (L-SIG) field), an EHT signal A field (EHT-SIG-A), an EHT signal B field (EHT-SIG-B), an EHT hybrid automatic repeat request field (EHT-HARQ), an EHT short training field (EHT-STF), an EHT long training field (EHT-LTF), and an EHT-DATA field. FIG. 7 includes a table 700, which describes fields of an EHT frame format. In particular, table 700 describes various fields that may be within the PHY preamble, data field, and midamble of an EHT frame format. For example, table 700 includes definitions 702, durations 704, Discrete Fourier transform (DFTs) periods 706, guard intervals (GIs) 708, and subcarrier spacings 710 for one or more of a legacy short training field (L-STF) 712, legacy long training field (L-LTF) 714, legacy signal field (L-SIG) 716, repeated L-SIG (RL-SIG) 718, universal signal field (U-SIG) 720, EHT signal field (EHT-SIG) 722, EHT hybrid automatic repeat request field (EHT-HARQ) 724, EHT short training field (EHT-STF) 726, EHT long training field (EHT-LTF) 728, EHT data field 730, and EHT midamble field (EHT-MA) 732.

The distributed nature of a channel access network, such as in IEEE 802.11 wireless networks, makes carrier sensing mechanisms important for collision free operation. The physical carrier sensing mechanism of one STA is responsible for detecting the transmissions of other STAs. However, it may be impossible to detect every single case in some circumstances. For example, one STA which may be a long distance away from another STA may see the medium as idle and begin transmitting a frame while the other STA is also transmitting. To overcome this hidden node, a network allocation vector (NAV) may be used. However, as wireless networks evolve to include simultaneous transmission/reception to/from multiple users within a single basic service set (BSS), such as uplink (UL)/downlink (DL) multi-user (MU) transmissions in a cascading manner, a mechanism may be needed to allow for such a situation. As used herein, a multi-user (MU) transmission refers to cases that multiple frames are transmitted to or from multiple STAs simultaneously using different resources. Examples of different resources are different frequency resources in OFDMA transmissions and different spatial streams in MU-MIMO transmissions. Therefore, DL-OFDMA, DL-MU-MIMO, UL-OFDMA, and UL-MU-MIMO are examples of MU transmissions.

Wireless network systems can rely on retransmission of media access control (MAC) protocol data units (MPDUs) when the transmitter (TX) does not receive an acknowledgement from the receiver (RX) or MPDUs are not successfully decoded by the receiver. Using an automatic repeat request (ARQ) approach, the receiver discards the last failed MPDU before receiving the newly retransmitted MPDU. With requirements of enhanced reliability and reduced latency, the wireless network system can evolve toward a hybrid ARQ (HARQ) approach.

There are two methods of HARQ processing. In a first type of HARQ scheme, also referred to as chase combining (CC) HARQ (CC-HARQ) scheme, signals to be retransmitted are the same as the signals that previously failed because all subpackets to be retransmitted use the same puncturing pattern. The puncturing is needed to remove some of the parity bits after encoding using an error-correction code. The reason why the same puncturing pattern is used with CC-HARQ is to generate a coded data sequence with forward error correction (FEC) and to make the receiver use a maximum-ratio combining (MRC) to combine the received, retransmitted bits with the same bits from the previous transmission. For example, information sequences are transmitted in packets with a fixed length. At a receiver, error correction and detection are carried out over the whole packet. However, the ARQ scheme may be inefficient in the presence of burst errors. To solve this more efficiently, subpackets are used. In subpacket transmissions, only those subpackets that include errors need to be retransmitted.

Since the receiver uses both the current and the previously received subpackets for decoding data, the error probability in decoding decreases as the number of used subpackets increases. The decoding process passes a cyclic redundancy check (CRC) and ends when the entire packet is decoded without error or the maximum number of subpackets is reached. In particular, this scheme operates on a stop-and-wait protocol such that if the receiver can decode the packet, it sends an acknowledgement (ACK) to the transmitter. When the transmitter receives an ACK successfully, it terminates the HARQ transmission of the packet. If the receiver cannot decode the packet, it sends a negative acknowledgement (NAK) to the transmitter and the transmitter performs the retransmission process.

In a second type of HARQ scheme, also referred to as an incremental redundancy (IR) HARQ (IR-HARQ) scheme, different puncturing patterns are used for each subpacket such that the signal changes for each retransmitted subpacket in comparison to the originally transmitted subpacket. IR-HARQ alternatively uses two puncturing patterns for odd numbered and even numbered transmissions, respectively. The redundancy scheme of IR-HARQ improves the log likelihood ratio (LLR) of parity bit(s) in order to combine information sent across different transmissions due to requests and lowers the code rate as the additional subpacket is used. This results in a lower error rate of the subpacket in comparison to CC-HARQ. The puncturing pattern used in IR-HARQ is indicated by a subpacket identity (SPID) indication. The SPID of the first subpacket may always be set to 0 and all the systematic bits and the punctured parity bits are transmitted in the first subpacket. Self-decoding is possible when the receiving signal-to-noise ratio (SNR) environment is good (i.e., a high SNR). In some embodiments, subpackets with corresponding SPIDs to be transmitted are in increasing order of SPID but can be exchanged/switched except for the first SPID.

To improve WLAN systems, AP cooperation has been discussed as a possible technology to be adopted in IEEE 802.11be, where there is high level classification depending on various AP cooperation schemes. For example, there is a first type of cooperation scheme in which data for a user is sent from a single AP (sometimes referred to as “coordinated”) and there is a second type of cooperation scheme in which data for a user is sent from multiple APs (sometimes referred to as “joint”).

For the coordinated scheme, multiple APs are 1) transmitting on the same frequency resource based on coordination and forming spatial nulls to allow for simultaneous transmission from multiple APs or 2) transmitting on orthogonal frequency resources by coordinating and splitting the spectrum to use the spectrum more efficiently. For the joint scheme, multiple APs are transmitting jointly to a given user.

Next-generation wireless LANs (WLANs) are evolving in the direction of reducing latency and power consumption and improving manageability and throughput to improve the reliability of WLAN connectivity.

In dense wireless networks (e.g., wireless local area networks (WLANs)), many wireless devices may transmit high throughput traffic. Wireless networks may use a distributed competition-based medium access mechanism, which generally has lower throughput efficiency compared to centrally-controlled medium access mechanisms due to overhead added by backoff time, interframe space (IFS), control/management frame exchanges, and frame headers.

Existing wireless networks that use a distributed competition-based medium access mechanism use techniques such as TXOP (transmit opportunity), aggregation, and block acknowledgment (ACK) to allow a single wireless device to occupy the medium access rights for a relatively long period of time to improve efficiency and significantly increase throughput.

The TXOP technique can help reduce distributed competition overhead and protocol/frame overhead by guaranteeing the transmission of a particular wireless device that has acquired the medium access rights through distributed competition. TXOP is an important technique that enables high-speed and large data transmissions (e.g., for multimedia applications) in wireless networks.

Next generation wireless networks are expected to be able to support real-time ultra-low latency applications such as augmented reality (AR), virtual reality (VR), industrial Internet of Things (IOT), connected cars, connected drones, multi-player gaming, and connected medical equipment, just to name a few examples. Therefore, there is a need to reduce latency in wireless networks while still maintaining compatibility with conventional high-throughput wireless devices.

In order to improve network throughput, a long TXOP should be granted and guaranteed to wireless devices to allow wireless devices to have exclusive access to the wireless medium for an extended period of time. However, at the same time, a network technology is needed that allows latency-sensitive wireless devices to access the medium during the TXOP with low latency. The ability to transmit latency-sensitive data (e.g., emergency data) with low latency may become an important feature of next-generation wireless networks.

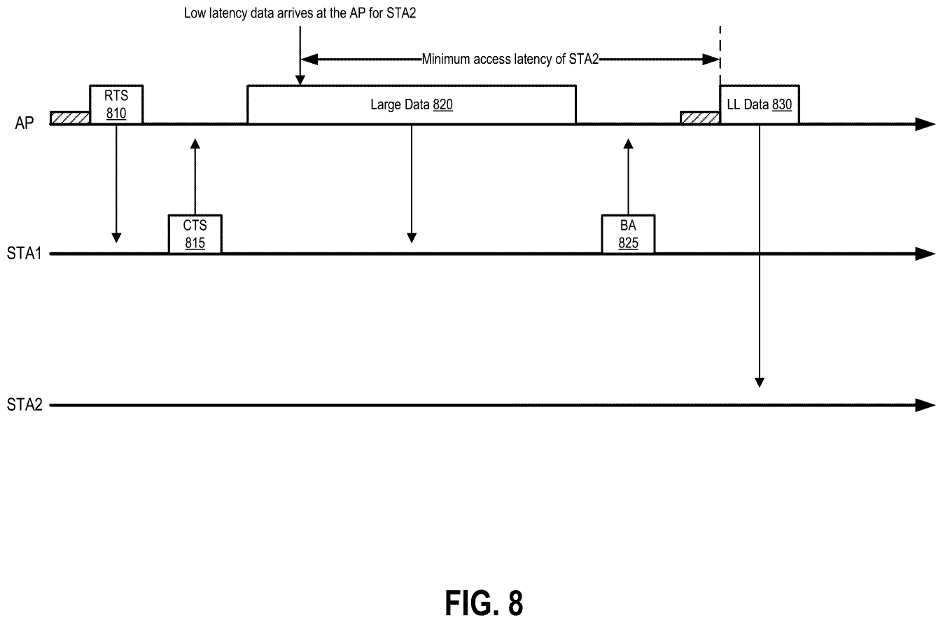

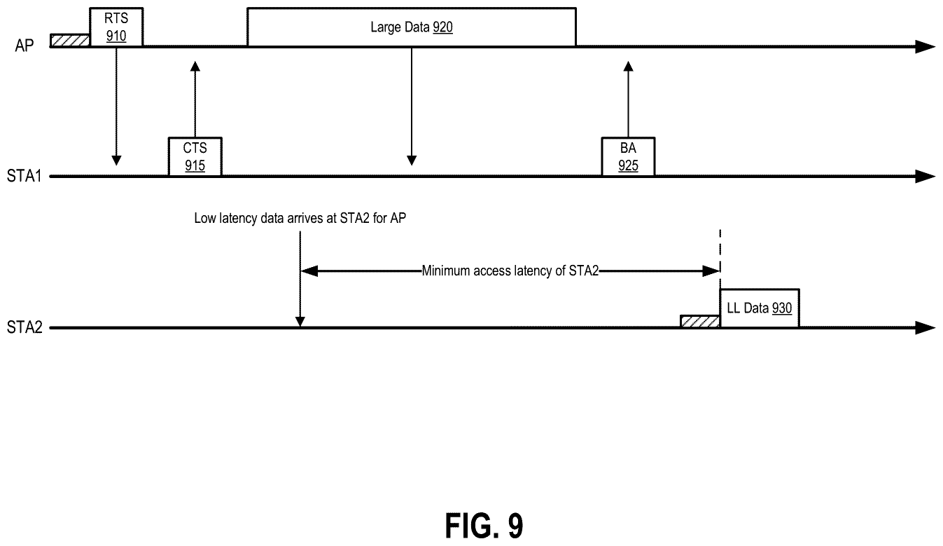

FIG. 8 and FIG. 9 are diagrams showing two situations in which an AP acquires a long TXOP and transmits a large data frame, which can delay the transmission of low latency data. In the situation shown in FIG. 8, the low latency transmitter is the TXOP holder. In the situation shown in FIG. 9, the low latency transmitter is not the TXOP holder.

FIG. 8 is a diagram showing a situation in which an AP transmits a large data frame, which delays the transmission of the AP's low latency data.

As shown in the diagram, the AP may transmit a RTS (request-to-send) frame 810 to STA1 and STA1 may respond by transmitting a CTS (clear-to-send) frame 815 to the AP. In this case, the AP is the TXOP holder. The AP may then transmit a large data frame 820 to STA1 during the TXOP. STA1 may then transmit a block acknowledgement (ACK) frame 825 to the AP if it successfully receives the large data frame 820.

As shown in the diagram, the AP may determine that it has low latency data to transmit to STA2 during the middle of the transmission of the large data frame 820. In this case, the AP cannot transmit a low latency data frame 830 (that includes the low latency data) to STA2 until after the AP finishes transmitting the large data frame 820 to STA1 and also after STA1 finishes transmitting the block ACK frame 825 to the AP. As a result, there is a minimum access latency for the AP to transmit the low latency data frame 830 to STA2.

FIG. 9 is a diagram showing a situation in which an AP transmits a large data frame, which delays the transmission of a LLT STA's low latency data.

As shown in the diagram, the AP may transmit a RTS frame 910 to STA1 and STA1 may respond by transmitting a CTS frame 915 to the AP. In this case, the AP is the TXOP holder. The AP may transmit a large data frame 920 to STA1 during the TXOP. STA1 may then transmit a block ACK frame 925 to the AP if it successfully receives the large data frame 920.

As shown in the diagram, STA2 may determine that it has low latency data to transmit to the AP during the middle of the transmission of the large data frame 920. In this case, STA2 is a low latency transmission (LLT) STA that is not a TXOP holder. As used herein, a LLT STA may be a STA that has low latency data to transmit. A non-LLT STA may be a STA that has non-low latency data to transmit. It should be understood that a particular STA can be a LLT STA in some situations and be a non-LLT STA in other situations. In the example shown in the diagram, STA2 cannot transmit a low latency data frame 930 (that includes the low latency data) to the AP until after the AP finishes transmitting the large data frame 920 to STA1 and also after STA1 finishes transmitting the block ACK frame 925 to the AP. That is, STA2 must wait for the TXOP of the AP to expire before it can transmit a low latency data frame 930 to the AP. As a result, there is a minimum access latency for STA2 to transmit the low latency data frame 930 to the AP.

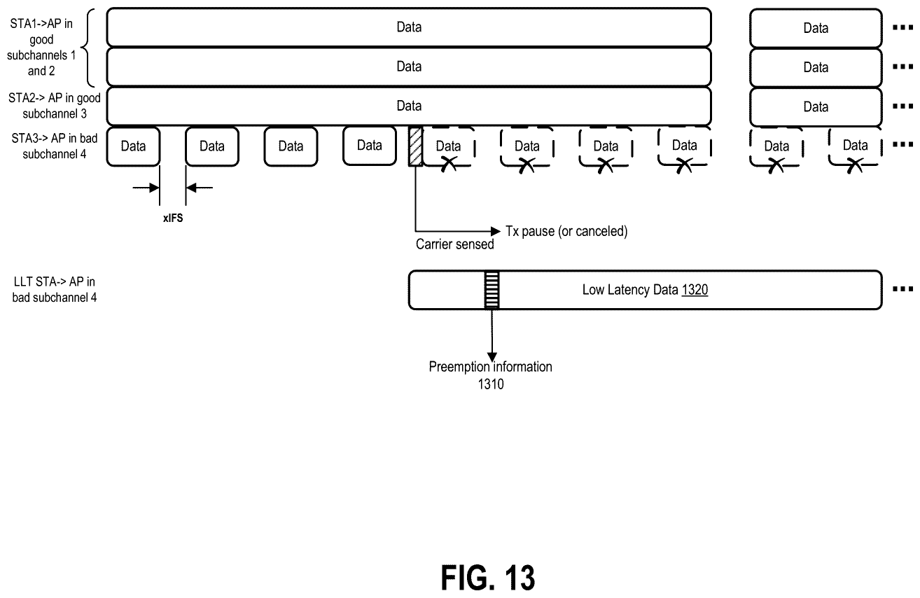

One technique to reduce the latency of low latency transmissions is to allow transmissions to overlap during the TXOP. With such an overlapped transmission technique, the LLT STA (e.g., STA2 in FIG. 9) is allowed to transmit low latency data in the middle of the non-LLT STA's (e.g., AP in FIG. 9) TXOP while the non-LLT STA is actively transmitting. At this time, a method of selectively transmitting low latency data based on CQI (Channel Quality Indication) may be used to prevent the transmission of non-LLT STA as much as possible. A wireless device waits to avoid collisions when other wireless devices are transmitting. Thus, low latency transmission may be possible if overlapped transmission is based on CQI. For example, as shown in FIG. 13 and will be further described herein, allowing low latency transmission in a subchannel with poor channel quality (e.g., subchannel 4 in FIG. 13) instead of a subchannel with good channel quality may be beneficial for both the non-LLT STAs and LLT STAs.

However, a drawback of such overlapped transmission technique is that the quality of the signal may be degraded due to signal interference between the LLT STA's transmission and the non-LLT STA's transmission. This may cause the transmission/reception of the low latency data to fail, which may result in additional latency (e.g., due to having to retransmit the low latency data).

Another technique to reduce the latency of low latency data transmissions is to pause the TXOP and allow low latency transmission based on signaling for preemption. Alternatively, a link or channel dedicated for preemption can be allocated before the TXOP.

However, such preemption signaling technique has a few drawbacks. Low latency traffic consists mostly of short frames so adding additional signaling to allow for preemption becomes overhead, resulting in minimal latency reduction. Also, low latency traffic has sporadic characteristics, making it difficult to implement the signaling needed to preempt the TXOP.

To address one or more of such limitations, embodiments allocate PPDU transmission length differentially for each link/channel without overlapped transmission (thus avoiding the drawbacks of overlapped transmission techniques) and allow low latency transmission in the inter-frame space section between PPDU transmissions (without needing additional signaling, thereby avoiding the drawbacks of preemption signaling techniques).

Embodiments are able to overcome the drawbacks of the overlapped transmission technique and the preemption signaling technique by having a non-LLT STA transmit differential PPDUs using a xIFS interval, where LLT STAs are allowed to preempt the transmission of the non-LLT STA by transmitting a preempting PPDU that includes low latency data during a xIFS interval. With embodiments, the preempting PPDU is transmitted during a xIFS interval and does not overlap with the non-LLT STA's transmission. Also, with embodiments, no additional signaling exchanges need to take place to preempt a transmission.

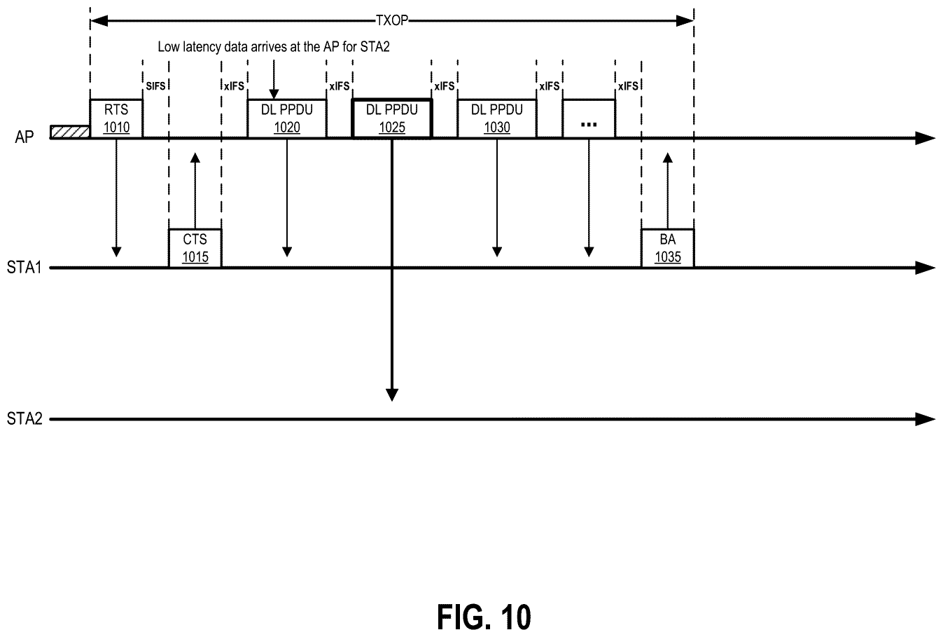

FIG. 10 is a diagram showing an AP transmitting differential PPDUs and preempting its own transmission to transmit downlink low latency data, according to some embodiments.

As shown in the diagram, the AP may transmit a RTS frame 1010 to STA1 and STA1 may respond by transmitting a CTS frame 1015 to the AP after a SIFS interval. In this case, the AP is the TXOP holder. After a xIFS interval following reception of the CTS frame 1015, the AP may transmit a DL PPDU 1020 that includes non-low latency data to STA1.

xIFS may be an IFS for allowing low latency transmission via preemption. In an embodiment, xIFS is the sum of sIFS and Tpcs.

sIFS may be an IFS for allowing signal processing. In an embodiment, SIFS is SIFS or RIFS or other IFS used in the wireless network. SIFS may correspond to an amount of time that is required for a wireless device to process a received frame and to respond with a response frame.

Tpcs may be the time period required for physical carrier sensing (PCS) to support preemption.

As shown in the diagram, the AP may determine that it has low latency data to transmit to STA2 during the middle of transmitting DL PPDU 1020 to STA1. Thus, after a xIFS interval following the transmission of DL PPDU 1020, the AP may transmit DL PPDU 1025, which includes the low latency data, to STA2.

After a xIFS interval following the transmission of DL PPDU 1025, the AP may resume transmission to STA1 using a xIFS interval. For example, the AP may transmit DL PPDU 1030 and possibly additional DL PPDUs that include non-low latency data to STA1 using a xIFS interval. The DL PPDUs that are transmitted to STA1 using a xIFS interval may be considered as differential PPDUs.

If STA1 successfully receives the differential DL PPDUs (e.g., DL PPDU 1020, DL PPDU 1030, and possibly additional DL PPDUs), STA1 may transmit a block ACK frame 1035 to the AP.

In this manner, the AP may divide/fragment long PPDUs into shorter PPDUs and transmit them using a xIFS interval to allow low latency transmission. As previously mentioned, xIFS may be determined as the sum of sIFS and Tpcs.

A LLT STA may preempt the transmission of a TXOP holder (e.g., the AP in FIG. 10) by transmitting during the xIFS interval between differential PPDUs transmitted by the TXOP holder. In this way, the LLT STA can stop/pause the transmission of the TXOP holder and access the wireless medium.

When the TXOP holder has low latency data to transmit, it may transmit the low latency data (in a PPDU) after transmitting one of the differential PPDUs. That is, the TXOP holder may transmit a preempting PPDU with low latency data between the transmission of two differential PPDUs.

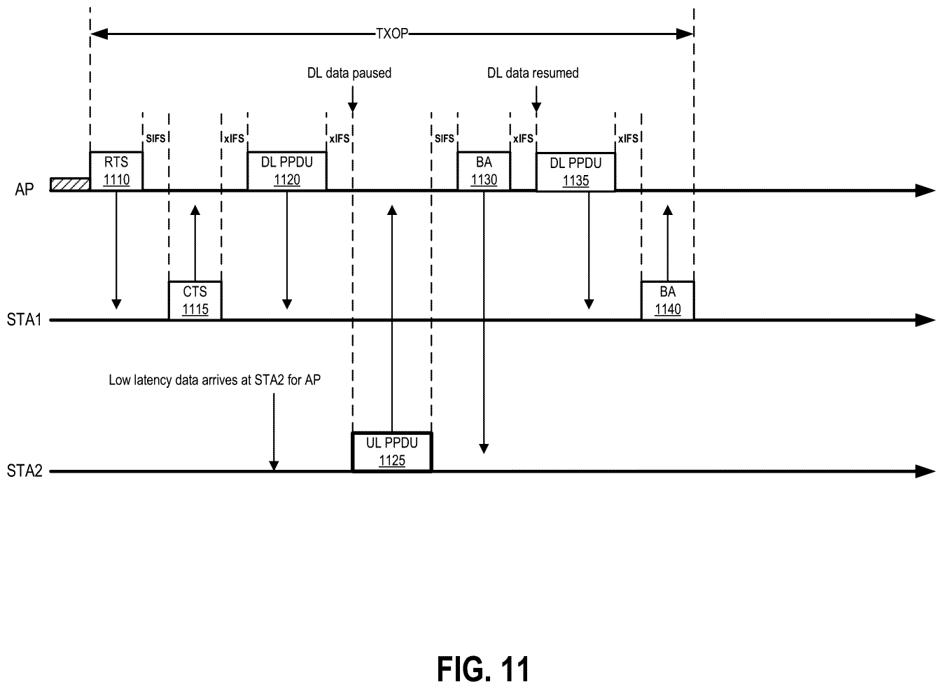

FIG. 11 is a diagram showing an AP transmitting differential PPDUs and a STA preempting the AP's transmission to transmit uplink low latency data, according to some embodiments.

As shown in the diagram, the AP may transmit a RTS frame 1110 to STA1 and STA1 may respond by transmitting a CTS frame 1115 to the AP after a SIFS interval. In this case, the AP is the TXOP holder. After a xIFS interval following reception of the CTS frame 1115, the AP may transmit a DL PPDU 1120 that includes non-low latency data to STA1.

As shown in the diagram, STA2 may determine that it has low latency data to transmit to the AP during the middle of the AP's transmission of DL PPDU 1120. Thus, during the xIFS interval following the transmission of the AP's transmission of the DL PPDU 1020, STA2 may transmit a UL PPDU 1125 that includes the low latency data to the AP.

In response to detecting the UL PPDU 1125, the AP may pause transmission of further PPDUs to STA1, receive the UL PPDU 1125, and transmit a block ACK frame 1130 after a SIFS interval to STA2 if the AP successfully receives the UL PPDU 1125. After a xIFS interval following the transmission of the block ACK frame 1130, the AP may resume transmission to STA1. For example, the AP may transmit DL PPDU 1135 to STA1 using a xIFS interval. The DL PPDUs that the AP transmits to STA1 using a xIFS interval (e.g., DL PPDU 1120 and DL PPDU 1135) may be considered as differential PPDUs. If STA1 successfully receives the DL PPDUs (e.g., DL PPDU 1120 and DL PPDU 1135), STA1 may transmit a block ACK frame 1140 to the AP.

Using the xIFS interval to transmit PPDUs allows a LLT STA (e.g., STA2) to preempt the transmission of the TXOP holder (e.g., the AP in FIG. 11) so that the LLT STA can transmit low latency data without having to wait for the TXOP to expire.

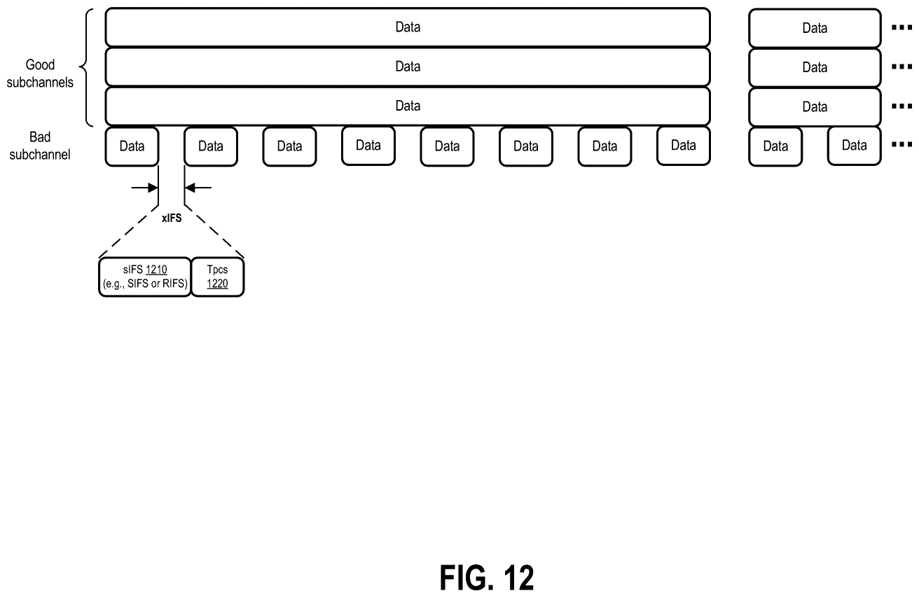

FIG. 12 is a diagram showing transmission of different length PPDUs in different subchannels, according to some embodiments.

As shown in the diagram, PPDUs (the “Data” shown in the diagram) may be transmitted in four subchannels. The four subchannels may include three good subchannels (subchannels having good channel quality) and one bad subchannel (a subchannel having bad channel quality). In the bad subchannel, data may be divided into smaller chunks and transmitted in shorter PPDUs using a xIFS interval. Each xIFS interval may include a sIFS interval 1210 and a Tpcs interval 1220. In the good subchannels, data may be transmitted in longer PPDUs. In an embodiment, a xIFS interval is used in each subchannel in which low latency transmission (preemption of the transmission) is allowed.

In an embodiment, a wireless device transmits relatively short PPDUs using a xIFS interval in bad subchannels (e.g., subchannels having a low SNR) and transmits relatively long PPDUs using a xIFS interval in good channels (e.g., subchannels having high SNR).

Since relatively short PPDUs are transmitted in the bad subchannel, wireless devices having low latency data to transmit may transmit the low latency data in the bad subchannel during a xIFS interval for shorter latency transmission. Since it is generally advantageous to transmit long PPDUs in good subchannels and short PPDUs in bad channels, transmitting PPDUs in the manner described above may help improve the performance of multilink/multichannel operations.

FIG. 13 is a diagram showing a pause in transmission during a TXOP due to preemption, according to some embodiments.

In the example shown in the diagram, it is assumed that a basic service set (BSS) includes an AP, three non-LLT STAs (STA1, STA2, and STA3), and one LLT STA. Also, in the example shown in the diagram, it is assumed that there are four subchannels (subchannels 1-4), where subchannels 1-3 are considered good subchannels (e.g., subchannels having a high SNR) and that subchannel 4 is considered to be a bad subchannel (e.g., a subchannel having a low SNR).

As shown in the diagram, STA1 may transmit long PPDUs (the “Data” shown in the diagram) to the AP in good subchannels 1 and 2. Also, STA2 may transmit long PPDUs to the AP in good subchannel 3. STA3 may transmit relatively short PPDUs in bad subchannel 4 using a xIFS interval. That is, STA3 may transmit differential PPDUs to allow low latency transmission.

If the LLT STA has low latency data to transmit, the LLT STA may transmit a preempting PPDU 1320 with the low latency data immediately after sIFS interval of a xIFS interval following a short PPDU transmitted by STA3 in subchannel 4. STA3 and the AP may then detect the preempting PPDU 1320 that includes the low latency data during the Tpcs interval of xIFS interval (based on channel sensing). Responsive to detecting the preempting PPDU, STA3 may pause or cancel further transmission to the AP in subchannel 4 (as depicted by the “x” marks in the diagram).

In an embodiment, the preempting PPDU 1320 includes a preemption information field 1310. The preemption information field 1310 may include bandwidth information for low latency transmission and transmission time information for low latency transmission. The bandwidth information for low latency transmission may indicate the bandwidth used for low latency transmission. The transmission time information for low latency transmission may indicate the length of the low latency transmission (i.e., how long the low latency transmission will last).

A block ACK frame may be transmitted by the AP after receiving SIFS-separated data frames from STA3 in the TXOP period, and normal ACK frame for data frames can be transmitted by the AP without additional competition during the TXOP period.

In an embodiment, only the first differential PPDU includes a legacy preamble to protect against transmissions by legacy devices, and subsequent differential PPDUs are transmitted using a green field format without a legacy preamble.

In the example shown in the diagram, PPDUs are shown as being transmitted in different subchannels in a synchronous manner. However, it should be appreciated that PPDUs can be transmitted in different subchannels in an asynchronous manner.

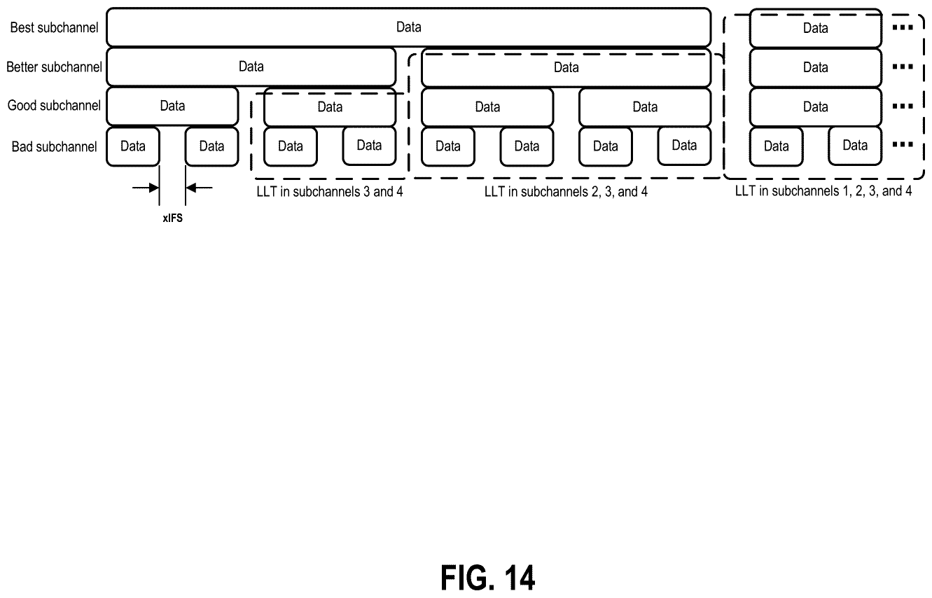

FIG. 14 is a diagram showing bandwidth expansion of low latency transmission, according to some embodiments.

As previously mentioned, longer PPDUs can be transmitted in good subchannels and shorter PPDUs can be transmitted in bad subchannels. In the example shown in the diagram, PPDUs are transmitted in four different subchannels: a bad subchannel (subchannel 4), a good subchannel (subchannel 3), a better subchannel (subchannel 2), and a best subchannel (subchannel 1). The bad subchannel has the poorest channel quality, the good subchannel has better channel quality than the bad subchannel, the better subchannel has better channel quality than the good subchannel, and the best subchannel has the best channel quality. Also, in the example shown in the diagram, the PPDUs (the “Data” shown in the diagram) transmitted in the best channel are the longest, the PPDUs transmitted in the better subchannel are the next longest, the PPDUs transmitted in the good subchannel are the next longest, and the PPDUs transmitted in the bad subchannel are the shortest. The PPDUs may be transmitted using a xIFS interval. In such transmission scheme, as it will be described in additional detail herein, it is possible to dynamically expand and/or contract the bandwidth of a low latency transmission.

In an embodiment, a wireless device can expand the bandwidth of its low latency transmission based on carrier sensing subchannels. For example, as shown in the diagram, a wireless device that has low latency data to transmit may preempt transmission in the bad subchannel (subchannel 4) and the good channel (subchannel 3) and transmit low latency data in the bad subchannel and the good subchannel (shown as the dashed box labeled “LLT in channels 3 and 4” in the diagram). During a xIFS interval in the better subchannel (subchannel 2), the wireless device may preempt the transmission in the better subchannel and start transmitting low latency data in the better subchannel, in addition to transmitting in the bad subchannel and the good subchannel, thereby expanding the bandwidth being used to transmit low latency data (so that the wireless device is transmitting low latency data in three subchannels-this is shown as the dashed box labeled “LLT in channels 2, 3, and 4” in the diagram). Similarly, during a xIFS interval in the best subchannel (subchannel 1), the wireless device may preempt the transmission in the best subchannel and start transmitting low latency data in the best subchannel, in addition to transmitting in the bad subchannel, the good subchannel, and the better subchannel, thereby further expanding the bandwidth being used to transmit low latency data (so that the wireless device is transmitting low latency data in all four subchannels-this is shown as the dashed box labeled “LLT in channels 1, 2, 3, and 4” in the diagram).

In this way, a wireless device can preempt a TXOP holder's transmission during a TXOP to transmit low latency data and expand the bandwidth of its low latency transmission based on carrier sensing subchannels to further reduce the latency of its low latency transmission.

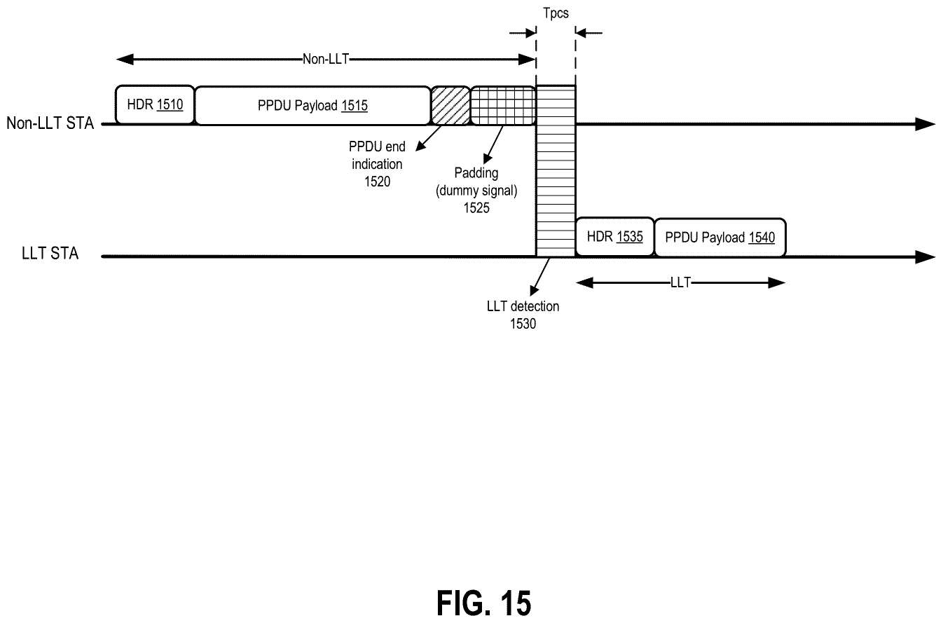

FIG. 15 is a diagram showing a PPDU end indication and padding to allow low latency transmission without having to wait for a sIFS interval, according to some embodiments.

As shown in the diagram, a non-LLT STA may transmit a PPDU that includes a header (HDR) 1510, a PPDU payload 1515, a PPDU end indication 1520, and padding 1525 (i.e., dummy signal). The PPDU end indication 1520 and the padding 1525 may be placed at or toward the end of the PPDU.

In general, a sIFS interval is needed following transmission of a PPDU to allow sufficient time for STAs receiving the PPDU to process the PPDU. If a new signal is transmitted following the transmission of a PPDU without waiting for the sIFS interval, a problem can arise where the receiving STA cannot start a new process (e.g., carrier sensing, timing synchronization, etc.) because the receiving process is not over.

To solve this problem and further reduce the latency of a low latency transmission by a LLT STA, a non-LLT STA may add a PPDU end indication to the end of a differential PPDU to inform STAs of the end of the differential PPDU. The non-LLT STA may also add padding following the PPDU end indication. The padding may help protect the low latency transmission and its length may vary depending on implementation.

LLT STAs that detect the PPDU end indication in the differential PPDU may further reduce the latency of their low latency transmissions by transmitting low latency data without waiting for a sIFS interval after receiving the PPDU. In this case, since the overlapped transmission does not physically collide with the signal, there is no performance degradation. For example, as shown in the diagram, the LLT STA may transmit a PPDU that includes HDR 1535 and a PPDU payload 1540 (with low latency data) during a Tpcs interval following the transmission of the padding 1525 to preempt the non-LLT STA's transmission without waiting for a sIFS interval.

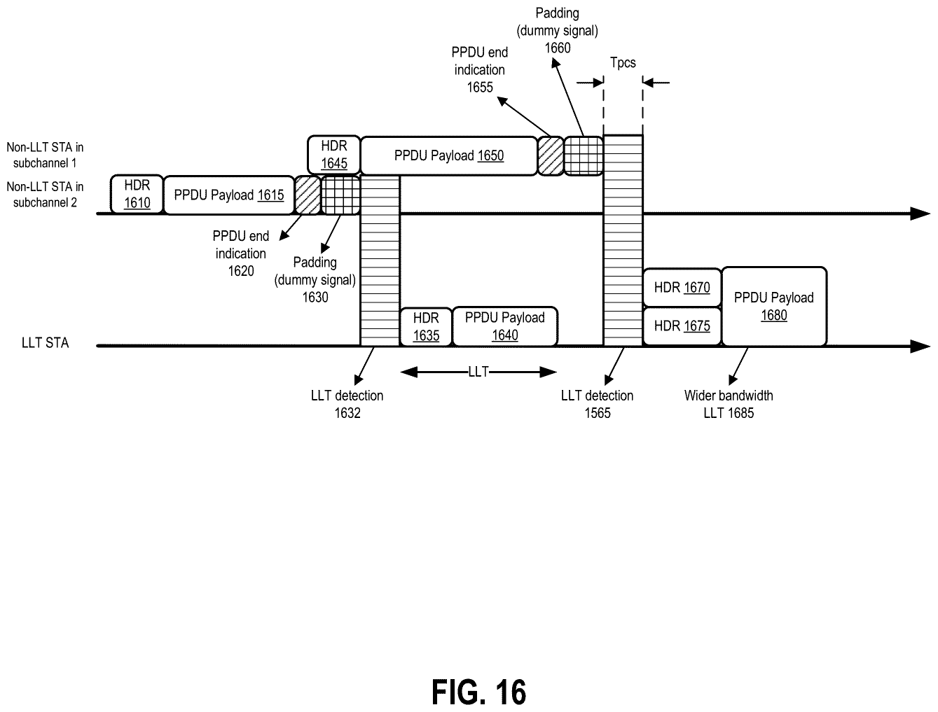

FIG. 16 is a diagram showing bandwidth expansion of low latency transmission based on detecting PPDU end indication, according to some embodiments.

As shown in the diagram, a non-LLT STA may transmit a PPDU that includes HDR 1610, PPDU payload 1615, PPDU end indication 1620, and padding 1630 in subchannel 2. Responsive to detecting PPDU end indication 1620, a LLT STA may preempt the transmission in subchannel 2 by transmitting a preempting PPDU in subchannel 2 during a LLT detection period 1632 (e.g., Tpcs interval) following the transmission of the non-LLT STA's PPDU in subchannel 2, without waiting for a sIFS interval. The LLT STA's preempting PPDU may include HDR 1635 and PPDU payload 1640.

As shown in the diagram, the non-LLT STA may transmit another PPDU that includes HDR 1645, PPDU payload 1650, PPDU end indication 1655, and padding 1660 in subchannel 1. Responsive to detecting PPDU end indication 1655, the LLT STA may preempt the transmission in subchannel 1 by transmitting a preempting PPDU in subchannel 1 during a LLT detection period 1665 (e.g., Tpcs interval) following the transmission of the non-LLT STA's PPDU in subchannel 1, without waiting for a sIFS interval. The LLT STA may continue to preempt the transmission in subchannel 2, which results in the LLT STA preempting transmissions in both subchannel 1 and subchannel 2, and thereby expanding the bandwidth of its low latency transmission. The LLT STA's PPDU may include HDR 1670 in subchannel 1 and HDR 1675 in subchannel 2 and also include PPDU payload 1680 that has a wider bandwidth 1685. In this way, the LLT STA may start off by transmitting low latency data only in subchannel 2 and then dynamically expand the bandwidth of its low latency transmission by transmitting in both subchannel 1 and subchannel 2 based on detecting PPDU end indication 1655 in subchannel 1, without having to wait for sIFS interval to further reduce latency. Thus, not only is latency reduced by transmitting low latency data using a wider bandwidth, but also by being able to preempt the non-LLT STA's transmission without having to wait for sIFS interval.

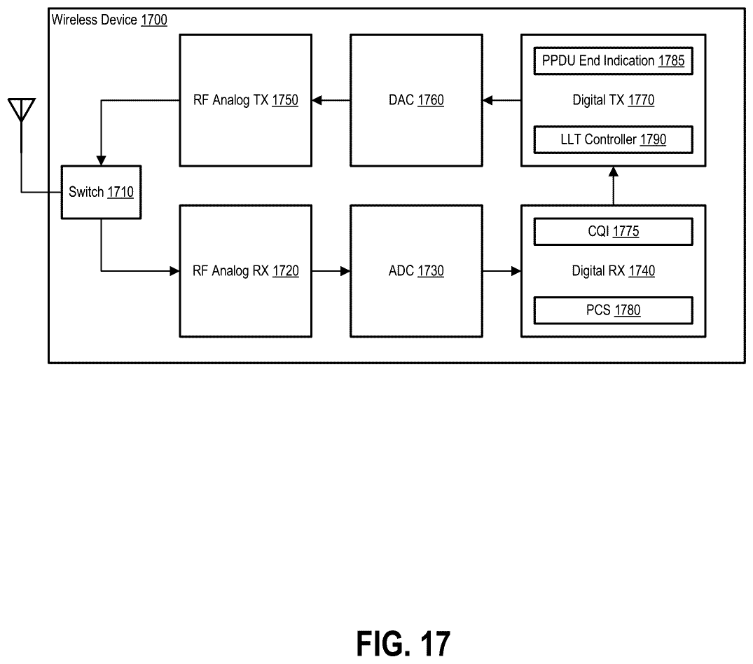

FIG. 17 is a diagram showing a configuration of a wireless device, according to some embodiments.

As shown in the diagram, the wireless device includes a digital transmitter (TX) 1770, a digital to analog converter (DAC) 1760, a RF analog TX 1750, a digital receiver (RX) 1740, a analog to digital converter (ADC) 1730, a RF analog RX 1720, and a switch 1710.

The switch 1710 may control whether transmission operations are being performed or reception operations are being performed.

The digital TX 1770 may generate digital signals for transmission. The digital TX 1770 may include a LLT controller 1790 and a PPDU end indication component 1785. The LLT controller 1790 may control low latency transmission operations of the wireless device 1700 (e.g., to generate differential PPDUs or generate preempting PPDUs). The PPDU end indication component 1785 may generate/insert PPDU end indication and padding to differential PPDUs (e.g., when the wireless device 1700 functions as a non-LLT STA) and detect PPDU end indication and padding (e.g., when the wireless device 1700 functions as a LLT STA).

The DAC 1760 may convert digital signals into analog signals.

The RF analog TX 1750 may generate analog radio-frequency signals for transmission.

The RF analog RX 1720 may receive analog radio-frequency signals transmitted by other wireless devices.

The ADC 1730 may convert analog signals into digital signals.

The digital RX 1740 may receive digital signals for processing. The digital RX 1740 may include a CQI measurement component 1775 and a physical carrier sensing (PCS) component 1780. The CQI measurement component 1775 may perform channel quality measurements (e.g., which can be used for identifying the subchannel in which to transmit differential PPDUs). The PCS component 1780 may perform physical carrier sensing (e.g., to detect preempting PPDUs).

In an embodiment where low latency data can be transmitted during a xIFS interval, performance degradation may occur due to signal collision caused by competition-based transmission of multiple different LLT STAs. LLT STAs are carrier sensing so if a first LLT STA transmits first, a second LLT STA will not access the channel if it sense the first LLT STA's transmission. However, if multiple LLT STAs simultaneously transmit low latency data such that carrier sensing is not possible, performance degradation may occur due to collisions.

To solve this problem, embodiments may include one or more of the following additional features.

First, the PPDU end indication may include information regarding the group of STAs that are allowed to transmit low latency data following the transmission of the PPDU. With this technique, not all LLT STAs are allowed to preempt a transmission by transmitting during a xIFS interval, but only the LLT STAs that are in the group specified in the PPDU end indication are allowed to transmit low latency data during a xIFS interval, which helps lower the probability of collisions.

Second, different LLT STA groups may be assigned different priorities, and each LLT STA group may have different waiting times (e.g., (xIFS or Tpcs)) for accessing the channel depending on the priorities of the LLT STA groups. For example, LLT STAs that are part of a high priority LLT STA group (LLT STA requiring shorter latency) may access the channel after waiting for a Tpcs interval, while LLT STAs that are part of a lower priority LLT STA group may access the channel after 2×Tpcs interval (two Tpcs intervals), thereby enabling differentiated channel access and lowering the probability of collisions.

Third, different LLT STAs may be assigned different channel access priorities depending on the category of the low latency data that they are to transmit. For example, a LLT STA that is to transmit high-priority data (e.g., latency sensitive data such as voice data) may access the channel after a Tpcs interval, while a LLT STA that is to transmit relatively low priority data (e.g., best effort data) may access the channel after a 2×Tpcs interval (two Tpcs intervals).

The embodiments disclosed herein can guarantee long TXOPs for high throughput STAs while at the same time give LLT STAs opportunities to access the channel during the middle of the TXOP in a wireless network that uses a distributed competition-based channel access mechanism. LLT STAs can preempt a transmission by transmitting low latency data during a xIFS interval between differential PPDUs. To further reduce delay, the LLT STA may dynamically expand the bandwidth used for preemption by preempting transmissions in additional subchannels in which differential PPDUs are being transmitted. Also, PPDU end indication and padding (dummy signal) may be added to the end of differential PPDUs to support even faster low latency transmission.

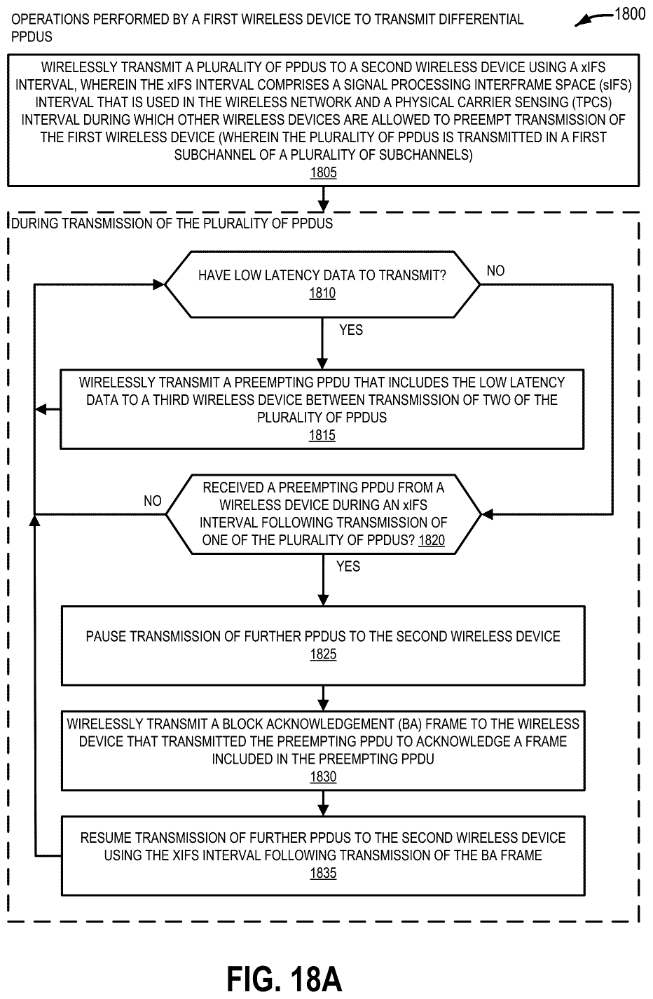

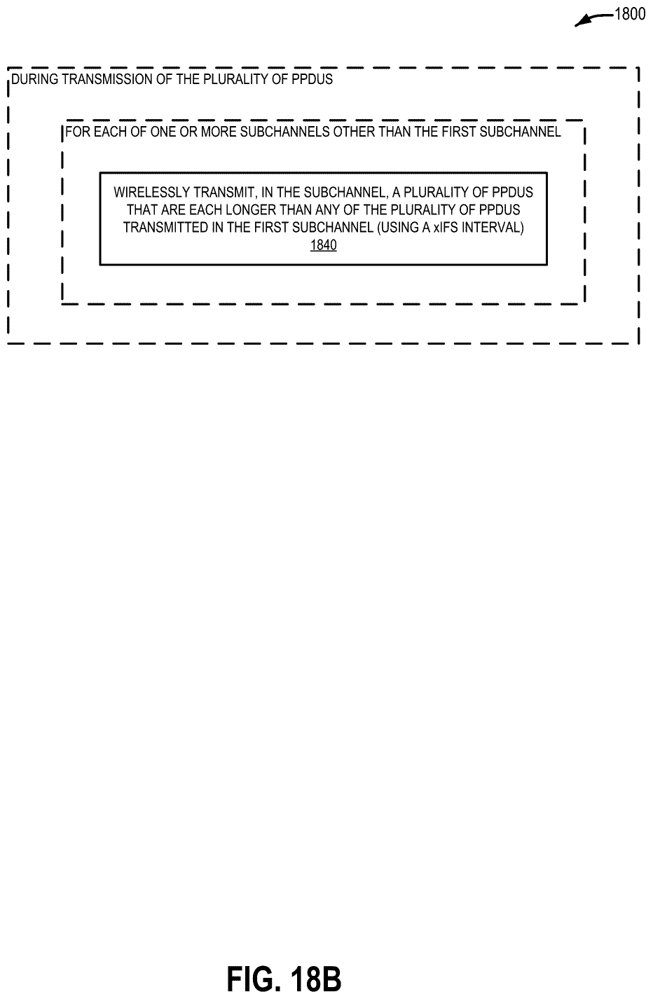

Turning now to FIG. 18A, a method 1800 will be described for transmitting differential PPDUs to allow low latency transmission, in accordance with an example embodiment. The method 1800 may be performed by one or more devices described herein. For example, the method 1800 may be performed by a first wireless device (e.g., a wireless device functioning as the AP in FIG. 11) in a wireless network that also includes a second wireless device (e.g., a wireless device functioning as STA2 in FIG. 11).

Additionally, although shown in a particular order, in some embodiments the operations of the method 1800 (and the other methods shown in the other figures) may be performed in a different order. For example, although the operations of the method 1800 are shown in a sequential order, some of the operations may be performed in partially or entirely overlapping time periods.

At operation 1805, the first wireless device wirelessly transmits a plurality of PPDUs to a second wireless device using a xIFS interval, wherein the xIFS interval comprises a signal processing interframe space (sIFS) interval that is used in the wireless network and a physical carrier sensing (Tpcs) interval during which other wireless devices are allowed to preempt transmission of the first wireless device. In an embodiment, the sIFS interval is a short interframe space (SIFS) interval or a reduced interframe space (RIFS) interval.

The first wireless device may perform operations 1810-1840 during the transmission of the plurality of PPDUs.

At operation 1810, the first wireless device determines whether it has low latency data to transmit. If the first wireless device has low latency data to transmit, then the flow moves to operation 1815, at which the first wireless device wireless transmits a preempting PPDU that includes the low latency data to a third wireless device between transmission of two of the plurality of PPDUs.

Returning to operation 1810, if the first wireless device does not have low latency data to transmit, the flow moves to operation 1820, at which the first wireless device determines whether it has received a preempting PPDU from another wireless device during an xIFS interval following transmission of one of the plurality of PPDUs. If the first wireless device has not received a preempting PPDU, the flow moves to operation 1810. Otherwise, if the first wireless device has received a preempting PPDU from another wireless device, the flow moves to operation 1815, at which the first wireless device pauses transmission of further PPDUs to the second wireless device.

At operation 1830, the first wireless device wirelessly transmits a block ACK frame to the wireless device that transmitted the preempting PPDU to acknowledge a frame included in the preempting PPDU.

At operation 1835, the first wireless device resumes transmission of further PPDU to the second wireless device using the xIFS interval following transmission of the block ACK frame.

In an embodiment, the first wireless device identifying a first subchannel of a plurality of subchannels that has a lowest signal-to-noise ratio (SNR) among the plurality of subchannels, and the first wireless device transmits the plurality of PPDUs in the first subchannel. In an embodiment, as shown in FIG. 18B, the first wireless device may perform operation 1840 for each of one or more subchannels other than the first subchannel in which the plurality of PPDUs are transmitted. At operation 1840, the first wireless device wirelessly transmits, in the subchannel, a plurality of PPDUs that are each longer than any of the plurality of PPDUs transmitted in the first subchannel. The plurality of PPDUs may be transmitted using a xIFS interval.

In an embodiment, responsive to determining that it has low latency data to transmit to a third wireless device, the first wireless device transmits a preempting PPDU that includes the low latency data to the third wireless device between transmission of two of the plurality of PPDUs.

In an embodiment, each of the plurality of PPDUs includes a PPDU end indication and padding following the PPDU end indication to allow other wireless devices to preempt transmission of the first wireless device without waiting for the xIFS interval. In an embodiment, the PPDU end indication includes information regarding which wireless devices are allowed to preempt the transmission of the first wireless device.

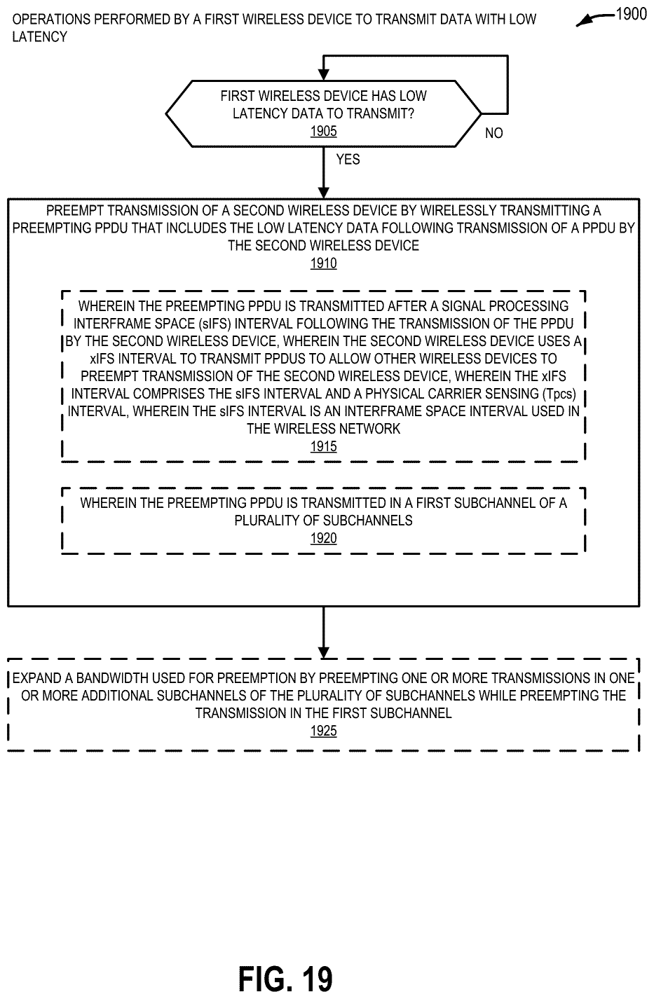

Turning now to FIG. 19, a method 1900 will be described for transmitting data with low latency, in accordance with an example embodiment. The method 1900 may be performed by one or more devices described herein. For example, the method 1900 may be performed by a first wireless device (e.g., a wireless device functioning as STA2 in FIG. 11) in a wireless network that also includes a second wireless device (e.g., a wireless device functioning as the AP in FIG. 11).

At operation 1905, the first wireless device determines whether it has low latency data to transmit. If the first wireless device does not have low latency data to transmit, it waits until it has low latency data to transmit. Otherwise, if the first wireless device has low latency data to transmit, the flow moves to operation 1910, at which the first wireless device preempts transmission of a second wireless device by wirelessly transmitting a preempting PPDU that includes the low latency data following transmission of a PPDU by the second wireless device.

In an embodiment, as shown in block 1915, the preempting PPDU is transmitted after a signal processing interframe space (sIFS) interval following the transmission of the PPDU by the second wireless device, wherein the second wireless device uses a x interframe space (xIFS) interval to transmit PPDUs to allow other wireless devices to preempt transmission of the second wireless device, wherein the xIFS interval comprises the sIFS interval and a physical carrier sensing (Tpcs) interval, wherein the sIFS interval is an interframe space interval used in the wireless network. In an embodiment, the sIFS interval is a short interframe space (SIFS) interval or a reduced interframe space (RIFS) interval.

In an embodiment, as shown in block 1920, the preempting PPDU is transmitted in a first subchannel of a plurality of subchannels. In an embodiment, at operation 1925, the first wireless device expands a bandwidth used for preemption by preempting one or more transmissions in one or more additional subchannels of the plurality of subchannels while still preempting the transmission in the first subchannel.

In an embodiment, the first wireless device detects a PPDU end indication in the PPDU transmitted by the second wireless device, wherein the preempting PPDU is transmitted without waiting for a signal processing interframe space (sIFS) interval following the transmission of the PPDU by the second wireless device responsive to detecting the PPDU end indication in the PPDU transmitted by the second wireless device.

Although many of the solutions and techniques provided herein have been described with reference to a WLAN system, it should be understood that these solutions and techniques are also applicable to other network environments, such as cellular telecommunication networks, wired networks, etc. In some embodiments, the solutions and techniques provided herein may be or may be embodied in an article of manufacture in which a non-transitory machine-readable medium (such as microelectronic memory) has stored thereon instructions which program one or more data processing components (generically referred to here as a “processor” or “processing unit”) to perform the operations described herein. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

In some cases, an embodiment may be an apparatus (e.g., an AP STA, a non-AP STA, or another network or computing device) that includes one or more hardware and software logic structures for performing one or more of the operations described herein. For example, as described herein, an apparatus may include a memory unit, which stores instructions that may be executed by a hardware processor installed in the apparatus. The apparatus may also include one or more other hardware or software elements, including a network interface, a display device, etc.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system may carry out the computer-implemented methods described herein in response to its processor executing a computer program (e.g., a sequence of instructions) contained in a memory or other non-transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method performed by a first wireless device in a wireless network to transmit differential physical layer protocol data units (PPDUs) to allow low latency transmission, the method comprising:
wirelessly transmitting a plurality of PPDUs to a second wireless device using a x interframe space (xIFS) interval, wherein the xIFS interval comprises a signal processing interframe space (sIFS) interval that is used in the wireless network and a physical carrier sensing (Tpcs) interval during which other wireless devices are allowed to preempt transmission of the first wireless device.

2. The method of claim 1, further comprising:
responsive to determining that the first wireless device has low latency data to transmit to a third wireless device, wirelessly transmitting a preempting PPDU that includes the low latency data to the third wireless device between transmission of two of the plurality of PPDUs.

3. The method of claim 1, further comprising:
wirelessly receiving a preempting PPDU from a third wireless device during an xIFS interval following transmission of one of the plurality of PPDUs;
responsive to receiving the preempting PPDU, pausing transmission of further PPDUs to the second wireless device;
wirelessly transmitting a block acknowledgment (BA) frame to the third wireless device to acknowledge a frame included in the preempting PPDU; and
resuming transmission of further PPDUs to the second wireless device using the xIFS interval following transmission of the BA frame.

4. The method of claim 1, further comprising:
identifying a first subchannel of a plurality of subchannels that has a lowest signal-to-noise ratio (SNR) among the plurality of subchannels, wherein the plurality of PPDUs is transmitted in the first subchannel.

5. The method of claim 4, further comprising:
wirelessly transmitting, during the transmission of the plurality of PPDUs, a second plurality of PPDUs that are each longer than any of the plurality of PPDUs in a second subchannel of the plurality of subchannels that is different from the first subchannel.

6. The method of claim 1, wherein each of the plurality of PPDUs includes a PPDU end indication and padding following the PPDU end indication to allow other wireless devices to preempt transmission of the first wireless device without waiting for the xIFS interval.

7. The method of claim 6, wherein the PPDU end indication includes information regarding which wireless devices are allowed to preempt the transmission of the first wireless device.

8. The method of claim 1, wherein the sIFS interval is a short interframe space (SIFS) interval or a reduced interframe space (RIFS) interval.

9. A method performed by a first wireless device in a wireless network to transmit data with low latency, the method comprising:
responsive to determining that that the first wireless device has low latency data to transmit, preempting transmission of a second wireless device by wirelessly transmitting a preempting physical layer protocol data unit (PPDU) that includes the low latency data following transmission of a PPDU by the second wireless device, wherein the second wireless device uses a x interframe space (xIFS) interval to transmit PPDUs to allow other wireless devices to preempt transmission of the second wireless device.

10. The method of claim 9, wherein the preempting PPDU is transmitted after a signal processing interframe space (sIFS) interval following the transmission of the PPDU by the second wireless device, wherein the xIFS interval comprises the sIFS interval and a physical carrier sensing (Tpcs) interval, wherein the sIFS interval is an interframe space interval used in the wireless network.

11. The method of claim 10, wherein the sIFS interval is a short interframe space (SIFS) interval or a reduced interframe space (RIFS) interval.

12. The method of claim 9, wherein the preempting PPDU is transmitted in a first subchannel of a plurality of subchannels.

13. The method of claim 12, further comprising:
expanding a bandwidth used for preemption by preempting one or more transmissions in one or more additional subchannels of the plurality of subchannels while preempting the transmission in the first subchannel.

14. The method of claim 9, further comprising:
detecting a PPDU end indication in the PPDU transmitted by the second wireless device, wherein the preempting PPDU is transmitted without waiting for a signal processing interframe space (sIFS) interval following the transmission of the PPDU by the second wireless device responsive to detecting the PPDU end indication in the PPDU transmitted by the second wireless device.

15. A first wireless device to operate in a wireless network, the first wireless device comprising:
a radio frequency transceiver;
a memory device storing a set of instructions; and
a processor coupled to the memory device, wherein the set of instructions when executed by the processor causes the wireless device to:
wirelessly transmit, using the radio frequency transceiver, a plurality of PPDUs to a second wireless device using a x interframe space (xIFS) interval, wherein the xIFS interval comprises a signal processing interframe space (sIFS) interval that is used in the wireless network and a physical carrier sensing (Tpcs) interval during which other wireless devices are allowed to preempt transmission of the first wireless device.

16. The first wireless device of claim 15, wherein the set of instruction when executed by the processor further causes the wireless device to:
responsive to determining that the first wireless device has low latency data to transmit to a third wireless device, wirelessly transmit a preempting PPDU that includes the low latency data to the third wireless device between transmission of two of the plurality of PPDUs.

17. The first wireless device of claim 15, wherein the set of instruction when executed by the processor further causes the wireless device to:
wirelessly receive, via the radio frequency transceiver, a preempting PPDU from a third wireless device during an xIFS interval following transmission of one of the plurality of PPDUs;
responsive to receiving the preempting PPDU, pause transmission of further PPDUs to the second wireless device;
wirelessly transmit, via the radio frequency transceiver, a block acknowledgment (BA) frame to the third wireless device to acknowledge a frame included in the preempting PPDU; and
resume transmission of further PPDUs to the second wireless device using the xIFS interval following transmission of the BA frame.

18. A first wireless device to operate in a wireless network, the first wireless device comprising:
a radio frequency transceiver;
a memory device storing a set of instructions; and
a processor coupled to the memory device, wherein the set of instructions when executed by the processor causes the wireless device to:
responsive to determining that that the first wireless device has low latency data to transmit, preempt transmission of a second wireless device by wirelessly transmitting, via the radio frequency transceiver, a preempting physical layer protocol data unit (PPDU) that includes the low latency data following transmission of a PPDU by the second wireless device, wherein the second wireless device uses a x interframe space (xIFS) interval to transmit PPDUs to allow other wireless devices to preempt transmission of the second wireless device.

19. The wireless device of claim 18, wherein the preempting PPDU is transmitted after a signal processing interframe space (sIFS) interval following the transmission of the PPDU by the second wireless device, wherein the xIFS interval comprises the sIFS interval and a physical carrier sensing (Tpcs) interval, wherein the sIFS interval is an interframe space interval used in the wireless network.

20. The wireless device of claim 19, wherein the sIFS interval is a short interframe space (SIFS) interval or a reduced interframe space (RIFS) interval.
